(19) United States
(12) Patent Application Publication
(10) Pub. No.: US 2025/0111392 A1
(43) Pub. Date: Apr. 3, 2025

(54) SYSTEMS AND METHODS FOR IMPROVING APPLICATION UTILIZATION

(71) Applicant: ATLASSIAN PTY LTD., Sydney (AU)

(72) Inventors: Mark Scarr, Mountain View, CA (US); Stephan Curiskis, Mountain View, CA (US); Zahra Eghtesadi, Mountain View, CA (US); David Yi, Mountain View, CA (US); Michael Johnson, Mountain View, CA (US); Jessica Vetorino, Mountain View, CA (US); Stephanie Lo, Mountain View, CA (US); Zahra Ghafoori, Mountain View, CA (US)

(21) Appl. No.: 18/478,459

(22) Filed: Sep. 29, 2023

(51) Int. Cl. G06Q 30/0202

(52) U.S. Cl. CPC G06Q 30/0202

(57) ABSTRACT

Systems and methods provide techniques for improving application utilization using prediction-based recommendations. In various embodiments, a method includes receiving user engagement data associated with a user-accessed application and an entity identifier of a particular entity and receiving historical user engagement data for additional entities associated with the user-accessed application and at least one of a plurality of candidate applications. The method includes determining a subset of the additional entities using a similarity analysis between the user engagement data and the historical user engagement data. The method includes generating, using a machine learning model, respective recommendation scores for the candidate applications based on the user engagement data, the machine learning model having been trained using a subset of the historical user engagement data corresponding to the subset of additional entities. The method includes generating a recommendation for the particular entity and one of the candidate applications based on the recommendation scores.

### BACKGROUND

Various methods, apparatuses, and systems are configured to provide techniques for generating predictive outputs to improve application utilization by end-users. Applicant has identified many deficiencies and problems associated with existing methods, apparatuses, and systems for increasing utilization of applications and application features by end-users. Through applied effort, ingenuity, and innovation, these identified deficiencies and problems have been solved by developing solutions that are in accordance with the embodiments of the present disclosure, many examples of which are described in detail herein.

### BRIEF SUMMARY

In general, embodiments of the present disclosure provide methods, apparatuses, systems, computing devices, and/or the like that are configured to enable targeted recommendation of applications and application features to one or more entities, such as one or more end-users or domain administrators. For example, certain embodiments of the present disclosure provide methods, apparatuses, systems, computing devices, and/or the like that are configured predict optimal applications and application features most likely to benefit and be utilized by one or more target entities.

In accordance with one aspect, a method is provided. In one embodiment, the method comprises: receiving, from at least one data store, user engagement data associated with at least one user-accessed application and an entity identifier of a particular entity; receiving, from the at least one data store, a corpus of historical user engagement data associated with a plurality of additional entities, wherein respective entities of the plurality of additional entities are associated with the at least one user-accessed application and at least one of a plurality of candidate applications; determining a subset of the plurality of additional entities associated with the particular entity by performing a similarity analysis between the user engagement data and the corpus of historical user engagement data; generating, using a machine learning model, respective recommendation scores for the plurality of candidate applications based on the user engagement data, wherein: the machine learning model was previously trained using a subset of the corpus of historical user engagement data corresponding to the subset of the plurality of additional entities; and the recommendation score indicates a likelihood of the particular entity performing at least one application action respective to the corresponding candidate application; generating a recommendation for the particular entity based on the respective recommendation scores, wherein the recommendation indicates at least one of the plurality of candidate applications; and causing provision of the recommendation to the at least one user-accessed application, wherein the user-accessed application causes provision of the recommendation to a computing device associated with the entity identifier.

In some embodiments, the at least one application action is at least one of an application purchase, an application version change, or an application trial. In some embodiments, the method further comprises generating a ranking of the plurality of candidate applications based on the respective recommendation scores, wherein the recommendation comprises a subset of top-ranked entries from the ranking for which the corresponding recommendation score meets a predetermined threshold.

In some embodiments, the method further comprises: generating, using a second machine learning model, a trigger event for causing provision of the recommendation to a computing device associated with the entity identifier, wherein: the second machine learning model was previously trained using the user engagement data and the subset of the corpus to generate predictive output indicative of optimal trigger events for recommending the at least one of the plurality of candidate applications; and in response to receiving an indication of an occurrence of the trigger event, causing the at least one user-accessed application to initiate the provision of the recommendation to the computing device associated with the entity identifier. In some embodiments, the trigger event comprises at least one action initiated by the particular entity within the at least one user-accessed application. In some embodiments, the trigger event comprises a particular time interval. In some embodiments, the trigger event comprises a predetermined utilization level of the at least one user-accessed application by the particular entity.

In some embodiments, the user engagement data comprises at least one application feature associated with the at least one user-accessed application or one or more historical user-accessed applications associated with the entity identifier. In some embodiments, the user engagement data further comprises at least one temporal feature associated with the at least one application feature. In some embodiments, the at least one application feature comprises at least one application action, and the at least one application action is at least one of an application purchase, an application upgrade, an application downgrade, or an application removal.

In some embodiments, the user engagement data and the corpus of historical user engagement data are received from a remote feature service comprising the at least one data store. In some embodiments, the method further comprises: providing, to a model service, a model request, wherein the model request indicates at least one of the at least one user-accessed application, the entity identifier, or the subset of the plurality of additional entities; and receiving, from the model service, the machine learning model, wherein the model service retrieves the machine learning model from a plurality of stored machine learning models based on the model request.

In some embodiments, the recommendation further indicates the corresponding recommendation score for the at least one of the plurality of candidate applications. In some embodiments, the method further comprises performing the similarity analysis by segmenting the plurality of additional users based on at least one segmentation factor to determine the subset of the plurality of additional entities associated with the particular entity. In some embodiments, the at least one segmentation factor comprises an application action record for the at least one user-accessed application. In some embodiments, the at least one segmentation factor comprises a predefined entitlement level for the at least one user-accessed application, and the predefined entitlement level is based on the user engagement data associated with the entity identifier. In some embodiments, the at least one segmentation factor comprises domain similarity between a domain associated with the particular entity and a respective domain associated with the plurality of additional entities. In some embodiments, the at least one segmentation factor comprises demographic similarity between demographic data associated with the particular entity and respective demographic data for the plurality of additional entities. In some embodiments, the user engagement data comprises the demographic data associated with the particular entity, and the corpus of historical user engagement data comprises the respective demographic data for the plurality of additional entities.

In some embodiments, the plurality of candidate applications comprises one or more first-party type applications and one or more second-party type applications; and the method further comprises filtering, from the respective recommendation scores, recommendation scores associated with the one or more second-party type applications such that the recommendation is generated based on a filtered subset of respective recommendation scores for the one or more first-party type applications. In some embodiments, the user engagement data comprises a domain identifier for a particular domain, and demographic data associated with the particular domain. In some embodiments, the user engagement data comprises an entitlement level of the particular entity for the at least one user-accessed application. In some embodiments, the user engagement data comprises an access interval corresponding to engagement of the particular entity with the at least one user-accessed application. In some embodiments, the user engagement data indicates a respective version of the at least one user-accessed application.

In accordance with another aspect, a second method is provided. In one embodiment, the method comprises: receiving, from at least one data store, user engagement data associated with at least one user-accessed application and an identifier of a particular domain, wherein the domain is associated with a plurality of end-users of a particular instance of the at least one user-accessed application; receiving, from the at least one data store, a corpus of historical user engagement data associated with a plurality of additional entities, wherein respective entities of the plurality of additional entities are associated with the at least one user-accessed application and at least one of a plurality of candidate applications; determining a subset of the plurality of additional entities associated with the particular domain by performing a similarity analysis between the user engagement data and the corpus of historical user engagement data; generating, using a machine learning model, respective recommendation scores for the plurality of candidate applications based on the user engagement data, wherein: the machine learning model was previously trained using a subset of the corpus of historical user engagement data corresponding to the subset of the plurality of additional entities; and the recommendation score indicates a likelihood of the plurality of end-users of the particular domain performing at least one application action respective to the corresponding candidate application; generating a recommendation for the particular domain based on the respective recommendation scores, wherein the recommendation indicates at least one of the plurality of candidate applications; and causing provision of the recommendation to the at least one user-accessed application, wherein the user-accessed application causes provision of the recommendation to a computing device associated with the identifier of the particular domain.

In some embodiments, the recommendation is provisioned to the computing device via rendering of a graphical user interface (GUI) on a display of the computing device. In some embodiments, the GUI comprises a user input field configured to receive user feedback to the recommendation from at least one of the plurality of end-users. In some embodiments, the method further comprises retraining the machine learning model using at least one user input received via the user input field. In some embodiments, the at least one application action is at least one of an application purchase, an application version change, or an application trial.

In some embodiments, the method further comprises generating a ranking of the plurality of candidate applications based on the respective recommendation scores, wherein the recommendation comprises a subset of top-ranked entries from the ranking for which the corresponding recommendation score meets a predetermined threshold. In some embodiments, the method further comprises generating, using a second machine learning model, a trigger event for causing provision of the recommendation to the computing device associated with the domain identifier, wherein: the second machine learning model was previously trained using the user engagement data and the subset of the corpus to generate predictive output indicative of optimal trigger events for recommending the at least one of the plurality of candidate applications; and in response to receiving an indication of an occurrence of the trigger event, causing the at least one user-accessed application to initiate the provision of the recommendation to the computing device associated with the domain identifier. In some embodiments, the trigger event comprises at least one action initiated by at least one of the plurality of end-users within the particular instance of the at least one user-accessed application. In some embodiments, the trigger event comprises a particular time interval. In some embodiments, the trigger event comprises a predetermined utilization level of the at least one user-accessed application by at least one of the plurality of end-users.

In some embodiments, the user engagement data comprises at least one application feature associated with the at least one user-accessed application or one or more historical user-accessed applications associated with the domain identifier. In some embodiments, the user engagement data further comprises at least one temporal feature associated with the at least one application feature. In some embodiments, the at least one application feature comprises at least one application action. In some embodiments, the at least one application action is at least one of an application purchase, an application upgrade, an application downgrade, or an application removal.

In some embodiments, the user engagement data and the corpus of historical user engagement data are received from a remote feature service comprising the at least one data store. In some embodiments, the method further comprises: providing, to a model service, a model request, wherein the model request indicates at least one of the at least one user-accessed application, the domain identifier, or the subset of the plurality of additional entities; and receiving, from the model service, the machine learning model, wherein the model service retrieves the machine learning model from a plurality of stored machine learning models based on the model request.

In accordance with another aspect, a computer program product is provided. The computer program product in some embodiments includes at least one non-transitory computer-readable storage medium having computer program code stored thereon. The computer program code in execution with at least one processor is configured for performing any one of the example computer-implemented methods described herein. In some embodiments, the at least one non-transitory computer-readable storage medium having computer program code comprising executable portions configured to: receive, from at least one data store, user engagement data associated with at least one user-accessed application, wherein the user engagement data is associated with an entity identifier of a particular entity; receive, from the at least one data store, a corpus of historical user engagement data associated with the particular entity and a plurality of additional entities, wherein respective entities of the plurality of additional entities are associated with the at least one user-accessed application and at least one of a plurality of candidate applications; determine a subset of the plurality of additional entities associated with the particular entity by performing a similarity analysis between (i) a dataset comprising the user engagement data and a subset of the corpus of historical user engagement data corresponding to the particular entity and (ii) a subset of the corpus of historical user engagement data corresponding to the plurality of additional entities; generate, using a machine learning model, respective recommendation scores for the plurality of candidate applications based on the user engagement data, wherein: the machine learning model was previously trained using a subset of the corpus of historical user engagement data corresponding to the subset of the plurality of additional entities; and the recommendation score indicates a likelihood of the particular entity performing at least one application action respective to the corresponding candidate application; generate a recommendation for the particular entity based on the respective recommendation scores, wherein the recommendation indicates at least one of the plurality of candidate applications; and cause provision of the recommendation to the at least one user-accessed application, wherein the at least one user-accessed application causes provision of the recommendation to a computing device associated with the entity identifier.

In accordance with yet another aspect, an apparatus comprising at least one processor and at least one memory including computer program code is provided. The computer program code in execution with the at least one processor causes the apparatus to perform any one of the example computer-implemented methods described herein. In some other embodiments, the apparatus includes means for performing each step of any of the computer-implemented methods described herein. In one embodiment, the at least one memory and the computer program code may be configured to, with the processor, cause the apparatus to: receive, from at least one data store, user engagement data associated with at least one user-accessed application, wherein the user engagement data is associated with an entity identifier of a particular entity; receive, from the at least one data store, a corpus of historical user engagement data associated with a plurality of additional entities, wherein respective entities of the plurality of additional entities are associated with the at least one user-accessed application and at least one of a plurality of candidate applications; determine a subset of the plurality of additional entities associated with the particular entity by performing a similarity analysis between the user engagement data and the corpus of historical user engagement data; generate, using a machine learning model, respective recommendation scores for the plurality of candidate applications based on the user engagement data, wherein: the machine learning model was previously trained using a subset of the corpus of historical user engagement data corresponding to the subset of the plurality of additional entities; and the recommendation score indicates a likelihood of the particular entity performing at least one application action respective to the corresponding candidate application; generate a recommendation for the particular entity based on the respective recommendation scores, wherein the recommendation indicates at least one of the plurality of candidate applications; and cause provision of the recommendation to the at least one user-accessed application, wherein the at least one user-accessed application causes provision of the recommendation to a computing device associated with the entity identifier.

### BRIEF DESCRIPTION OF THE SEVERAL VIEWS OF THE DRAWINGS

Having thus described some embodiments in general terms, references will now be made to the accompanying drawings, which are not drawn to scale, and wherein:

FIG. 1 is a block diagram of an example network environment in which a specially configured application recommendation system may operate in accordance with one or more embodiments of the present disclosure.

FIG. 2 is a block diagram of an example apparatus that may embody the specially configured application recommendation system in accordance with one or more embodiments of the present disclosure.

FIG. 3 is a block diagram of an example recommendation client device configured in accordance with at least some embodiments of the present disclosure.

FIG. 4 is a block diagram of an example model service of an application recommendation system in accordance with one or more embodiments of the present disclosure.

FIG. 5 is a cross-functional diagram of an example workflow for improving application utilization using predictive recommendations generated by a specially configured application recommendation system in accordance with at least some embodiments of the present disclosure.

FIG. 6 is a flowchart diagram of an example recommendation generation process for generating an application recommendation using one or more machine learning models in accordance with at least some embodiments of the present disclosure.

FIG. 7 provides a flowchart diagram of an example training process for training a machine learning model to generate predictive output for improving application utilization in accordance with at least some embodiments of the present disclosure.

### DETAILED DESCRIPTION OF VARIOUS EMBODIMENTS

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### Overview

Modern software users are presented with nearly limitless options in terms of potentially useful software applications. Available applications and application features may number in the hundreds to thousands, increasing the computational complexity of serving potential applications to users and reducing the efficiency of such users in discovering and utilizing appropriately configured applications to perform computer tasks. Further, the numerous options for applications, application versions, entitlement levels, features, and/or the like may result in further computational inefficiency due to a user engaging in trial-and-error attempts to identify and access appropriate applications for fulfilling a particular computer task.

To address the above-described challenges related to improving utilization and discovery of applications, various embodiments of the present disclosure described techniques for determining candidate applications most likely to be utilized by an entity based on current and historical user engagement data for one or more applications. For example, the technique may include generating recommendation scores for candidate applications by processing user engagement data of the entity using various machine learning techniques to predict a likelihood of the entity to engage with a respective candidate application. Machine learning models used to generate the predictive output may be previously trained using historical user engagement data for additional entities determined to demonstrate threshold-satisfying similarity to the entity.

By utilizing the noted techniques for determining candidate applications with which an entity is most likely to engage, various embodiments of the present disclosure incorporate predictive signals that indicate a predicted likelihood of the entity to engage with a candidate application or a particular version or feature of a candidate application. In doing so, the noted embodiments of the present disclosure can optimize the provision of application recommendations to a computing device and improve application utilization by identifying and indicating applications most likely to serve needs and interests of the entity. By improving the identification of applications, application versions, application features, and/or the like that are most likely to receive engagement from an entity, the described embodiments of the present disclosure enhance computational efficiency of generating and serving application recommendations within an application that is receiving engagement from the entity.

### Definitions

As used herein, the terms “data,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The terms “computer-readable storage medium” refers to a non-transitory, physical or tangible storage medium (e.g., volatile or non-volatile memory), which may be differentiated from a “computer-readable transmission medium,” which refers to an electromagnetic signal.

The term “recommendation client device” refers to computer hardware and/or software that is configured to access an application. Recommendation client devices may include, without limitation, smart phones, tablet computers, laptop computers, wearables, personal computers, enterprise computers, and the like.

As used herein, “application” refers to any program code executable by logic circuitry of one or more computing devices, such as a server processor. In some embodiments, an application is a computer program accessible to an entity via a computing device and which performs a specific function directly or indirectly for the entity, the computing device, another application, and/or the like. In some embodiments, an application includes a local software program installed and executed on a computing device accessible to an entity. In some embodiments, an application includes a remotely executed software program accessible to the entity via the entity's computing device and a suitable network connection to the corresponding remote computing environment.

Non-limiting examples of applications include local computer programs, remote computer programs, services, microservices, software modules, communication interfaces, and/or the like. In one example, an application may be a ticketing and project management service, such as Jira™. In another example, an application may be a cloud-based computing environment that enables collaborative workflows, such as Confluence™. In another example, an application may be a remote computing environment that provides program repository services, such as Bitbucket™. In still another example, an application may be an electronic mail (e-mail) and scheduling management platform. Other examples of applications include project visualization tools, incident management tools, user administration and authentication programs, collaborative work platforms, risk management and monitoring services, software testing tools, and/or the like. In some embodiments, application may refer to specific functions, features, services, and/or the like that are accessible using executable program code, or portion thereof. For example, application may refer to a specific functionality or action that may be performed using an application.

As used herein “user-accessed application” refers to any application currently receiving engagement from an entity. For example, a user-accessed application may be a software application installed on a computing device, where an entity is engaging with the software application using the computing device. As another example, a user-accessed application be a cloud-based application (e.g., a service, microservice, and/or the like) that an entity is currently accessing via a computing device and a suitable network connection to the corresponding cloud computing environment. In some embodiments, user-accessed application further refers to applications that historically received engagement from a user. In various embodiments discussed herein, the user-accessed application may provision recommendations to a recommendation client device, such as by causing rendering of graphical user interfaces (GUIs) or providing electronic communications, notifications, and/or the like.

As used herein, “candidate application” refers to any application that may be recommended to an entity for access and usage. In some embodiments, a candidate application is any application that has not been previously accessed by an entity or has not been previously accessed by the entity for a predetermined interval (e.g., 6 weeks, 6 months, 1 year, or any suitable time interval). For example, a candidate application may be an application that has never been accessed by an entity. In another example, a candidate application may be an application that has not been accessed by an entity for a predetermined interval. In some embodiments, a candidate application is any application for which an entity is not associated with a particular level of entitlement or any level of entitlement. For example, a candidate application may be an application that has not been purchased or otherwise accessed by an entity. In another example, a candidate application may be an application for which an entity is associated with a lower level of entitlement of a plurality of possible entitlement levels for the application. In such an example, the application may include multiple versions, such as a standard version, premium version, and an enterprise version, and the entity may hold a current entitlement to the standard version while lacking entitlement to the premium or enterprise versions. In some embodiments, a candidate application refers to one or more functions, features, or services of a user-accessed application that have not been accessed by an entity.

As used herein, “application action” refers to any action initiated by an entity, or a computing device of an entity, respective to an application or within the application. For example, an application action may include an entity evaluating an application, such as by trialing the application or accessing a description of the application. As another example, an application action may include an entity purchasing an application (or a subscription to the application), downloading an application, installing an application, uninstalling an application, transitioning between versions of an application, transitioning between levels of entitlement for an application (e.g., application upgrades, downgrades, etc.), and/or the like. In another example, an application action may include an entity engaging with an application, such as by accessing functions, features, services, and/or the like provisioned by the application. In another example, an application action may include an entity engaging in a temporary trial for the application (e.g., the entity being provisioned access to the application for a predetermined time interval and/or level of utilization).

As used herein, “user engagement data” refers to any data object associated with access or usage of an application by an entity. In some embodiments, user engagement data includes application features associated with an entity and one or more user-accessed applications for the entity. Application features may include application actions, narratives descriptive of application actions, temporal features of application actions, domain associations, entitlement level associations, identifications of user-accessed applications (including individual functions, features, services, and/or the like within an application), indications of associations between applications (e.g., such as between a first user-accessed application that utilizes data from a second user-accessed application). In some embodiments, the application features include one or more application actions performed within or respective to a user-accessed application. For example, an application feature may be a data object indicative of user engagement level with an application during a particular interval, such as whether an entity engaged with an application within 1 day, 2 days, 1 week, or any suitable interval following purchase of an application or upgrade of the application from a first version to a second version. The first version of the application may include, for example, a freemium version of the application, and the second version of the application may include a premium version or other paid version of the application. In some embodiments, user engagement data includes qualitative data associated with an entity and one or more user-accessed applications and/or candidate applications. For example, the user engagement data may include entity responses to surveys. The surveys may include questions related to application preferences, technical needs, satisfaction, application interest, and/or the like.

In some embodiments, the user engagement data includes temporal features associated with application usage. For example, the user engagement data includes timestamps corresponding to occurrences of application actions. In another example, the user engagement data includes durations of instances in which an entity engaged with an application. In some embodiments, the user engagement data indicates a level of utilization of a user-accessed application. For example, the user engagement data may indicate a utilization level including an amount of application resources utilized by an entity, such as a quantity of actions performed, amount of storage space utilized, application usage frequency, and/or the like. In some embodiments, the user engagement data includes one or more application action records as defined herein. In some embodiments, the user engagement data includes rate-based metrics or categorizations that indicate a frequency with which an entity performs an application action or a tendency of the entity to perform an application action. For example, the user engagement data may include a signup rate indicative of a frequency with which an individual user, group of users, or domain performs a signup action for new or recommended candidate applications. As another example, the user engagement data may include a signup rate indicative of a frequency with which an individual user, group of users, or domain purchases an application, upgrades from a free version of an application to a paid version of the application, or purchases premium features for the application. Alternatively, or additionally, the user engagement data may include associations between an entity with categories of user behavior (e.g., where such associations may also be generated by the application recommendation system described herein or received from an additional system). For example, the user engagement data for a particular entity may include an association of the particular entity with a low, medium, or high-level category of application purchasing, application trialing, application upgrading, and/or the like.

In some embodiments, the user engagement data includes demographic data associated with an entity. For example, the user engagement data includes an entity location, entity age, entity role, and/or the like. In another example, the user engagement data includes or indicates one or more industries, fields, subfields, or technology sectors with which an entity (or domain of the entity) is associated. In some embodiments, the user engagement data includes or indicates levels of entitlement of an entity for one or more applications. In some embodiments, the user engagement data includes or indicates an association of the entity with one or more domains, other entities, and/or the like. In some embodiments, the user engagement data includes firmographic data corresponding to one or more domains with which an entity is associated. In some embodiments, firmographic data refers to any data that describes attributes or operations of a domain. In some contexts, firmographic data may include domain industry, sector, field, subfield, and/or the like. As another example, firmographic data may include operation or customer locations associated with a domain. As another example, firmographic data may include size (e.g., number of employees, number of customers, market share, growth information, and/or the like), historical expenditures, budgetary data, domain revenue, ownership style, and/or the like.

As used herein, “application action record” refers to any data construct that indicates historical application actions performed by or otherwise associated with a particular entity and a user-accessed application. In some embodiments, the application action record is a time series record of application actions respective to a user-accessed application and associated with a particular entity. For example, an application action record for a particular entity and a particular user-accessed application may indicate an entity identifier for the particular entity, an application identifier for the particular user-accessed application, a first time-dated entry for an instance in which the entity purchased the user-accessed application, a second time-dated entry for an instance in which the entity upgraded the user-accessed application from a first version to a second version, and a third time-date entry for an instance in which the entity transitioned from a first level of entitlement to the user-accessed application to a second level of entitlement.

As used herein, “entity” refers to any user, domain, computing device, and/or the like that engages with an application, a provider or broker of an application, and/or the application recommendation system described herein. For example, an entity may be an individual that accesses one or more applications to perform a task. In another example, an entity may include any number of computing devices and/or other systems embodied in hardware, software, firmware, and/or the like that engage with one or more applications (e.g., automatically, in response to input from a user entity, and/or the like). In some embodiments, is associated with a domain as described herein. In some embodiments, an entity is a domain. For example, an entity may embody an administrator user for a domain, where the administrator user may manage applications and entitlements for a plurality of users. For purposes of illustration and explanation, various embodiments of the present techniques are described in a context of generating recommendations for individual users. It will be understood that the present techniques may also be performed to generate recommendations for groups of users and domains and that no limitation of the described invention to individual users is intended.

As used herein, “domain” refers to an administrative entity possessing administrative privileges for managing user entities, including access to applications and levels of entitlement to applications. In some embodiments, a domain is an organization-level customer or consumer of applications and includes a plurality of associated entities, where each entity may be provisioned access to one or more applications at a particular level of entitlement. In one example, a domain may be a software company, or software development team therewithin, and entities associated with the domain may include software developers and individuals fulfilling other technical roles. In some embodiments, a domain may be associated with a domain identifier. In some embodiments, an entity identifier includes a domain identifier such that parsing the entity identifier may provide the domain identifier. In some embodiments, historical user engagement data may include indications of one or more domains with which the historical user engagement data is associated. In some embodiments, a domain may be associated with demographic data including location, industry, field, subfield, technology sector, customers, personnel size, computing resource requirements, and/or the like.

As used herein, “machine learning model” refers to any algorithmic, statistical, and/or machine learning model that generates a particular output, or plurality thereof, based at least in part on one or more inputs. For example, the machine learning model may include or embody one or more functions with learnable parameters that map one or more feature values (e.g., input) to an output value. In some embodiments, the input includes user engagement data, and the output includes a recommendation score for one or more candidate applications. In some embodiments, the input includes user engagement data, and the output includes one or more recommended trigger events for initiating provision of a recommendation for one or more candidate applications to an entity. In some embodiments, the machine learning model is trained using one or more datasets including historical user engagement data associated with one or more entities. For example, a machine learning model may be trained using historical user engagement data for a user-accessed application and a plurality of candidate applications to predict a respective level of likelihood that an entity will perform an application action for each candidate application. The historical user engagement data may a subset of a corpus of historical user engagement data that is associated with entities previously determined to be similar to a target entity for which the machine learning model is generating predictive output. For example, the subset of historical user engagement data used to train the model may be associated with entities that demonstrate the same level of entitlement to the user-accessed application as the target entity. The trained machine learning model may be stored in a model registry for subsequent retrieval and use in response to a recommendation request. In another example, a second machine learning model may be trained to predict optimal trigger events for serving a recommendation using the subset of historical user engagement data in combination with user engagement data associated with the target entity. In some embodiments, machine learning models include collaborative filter models, factorization machines, linear programming (LP) models, regression models, dimensionality reduction models, ensemble learning models, reinforcement learning models, supervised learning models, unsupervised learning models, semi-supervised learning models, Bayesian models, decision tree models, linear classification models, artificial neural networks, association rule learning models, hierarchical clustering models, cluster analysis models, anomaly detection models, deep learning models, feature learning models, and/or the like.

As used herein, “recommendation score” refers to a value that indicates a likelihood of an entity performing one or more application actions respective to a candidate application, such as purchasing the application, transitioning a user-accessed application from a current version to a version associated with the candidate application, and/or the like. As described herein, the entity may embody an individual user, a group of users, or a collective that manages users, such as a domain. The recommendation score may be a likelihood of an individual user, a group of users, or a domain performing an action respective to an application. In some embodiments, the recommendation score is a predicted level of benefit of the entity performing the application action. In some embodiments, the recommendation is a scaled value. For example, the recommendation score may be a value in the range of 0.0-1.0 where a recommendation score 0.0 corresponds to a lowest level of likelihood that an entity will purchase the candidate application (e.g., or perform another suitable application action) and 1.0 corresponds to a greatest level of likelihood that the entity will purchase the candidate application.

As used herein, “trigger event” refers to any number of conditions, factors, signals, and/or the like that, upon detection, may result in provision of a recommendation to an entity (e.g., via transmission of the recommendation to a computing device of the entity, rendering of a graphical user interface (GUI) including the recommendation, and/or the like). In some embodiments, the trigger event indicates one or more application actions that, upon being initiated by the entity, result in a recommendation being provisioned to the entity. For example, the trigger event may be an upgrade of a user-accessed application from a standard version (e.g., associated with a first set of functions) to a premium version (e.g., associated with the first set of functions and additional functions) such that, upon the entity upgrading the user-accessed application, a recommendation for purchasing a candidate application is provisioned to the entity. In some embodiments, the trigger event indicates a time interval, where elapse of the time interval results in provision of a recommendation to the entity. For example, the trigger event may be a particular date and/or time at which to provision a recommendation to an entity. In some embodiments, the trigger event includes the entity obtaining a predetermined level of utilization for one or more user-accessed applications. For example, the trigger event may indicate a threshold value for usage frequency, resource utilization, and/or the like for a user-accessed application associated with an entity. In response to the present system detecting, or receiving an indication, that the entity has engaged with the user-application at the threshold value for usage frequency, resource utilization, and/or the like, the system may perform functionality for causing provision of the recommendation to the entity.

As used herein, “model request” refers to any data object that embodies a request for output from a machine learning model. For example, a model request to a first machine learning model may embody a request to receive a respective recommendation score for a plurality of candidate applications respective to a particular entity. In another example, a model request to a second machine learning model may embody a request to receive one or more trigger events for providing a recommendation for one or more candidate applications, such as a candidate application for which the first machine learning model generated a highest value of the recommendation score. In some embodiments, the model request includes or indicates (e.g., for purposes of receipt or retrieval) one or more inputs to the machine learning model. For example, the model request may include user engagement data associated with a target entity. In another example, the model request may include an entity identifier and/or one or more application identifiers that enable retrieval or receipt of user engagement data. In another example the more request may include user engagement data associated with the target entity and a corpus of historical user engagement data associated with a plurality of additional entities.

### Example System Architecture

Methods, apparatuses, and computer program products of the present disclosure may be embodied by any of a variety of devices. For example, the method, apparatus, and computer program product of an example embodiment may be embodied by a networked device (e.g., an enterprise platform), such as a server or other network entity, configured to communicate with one or more devices, such as one or more query-initiating computing devices. Additionally, or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, or any combination of the aforementioned devices.

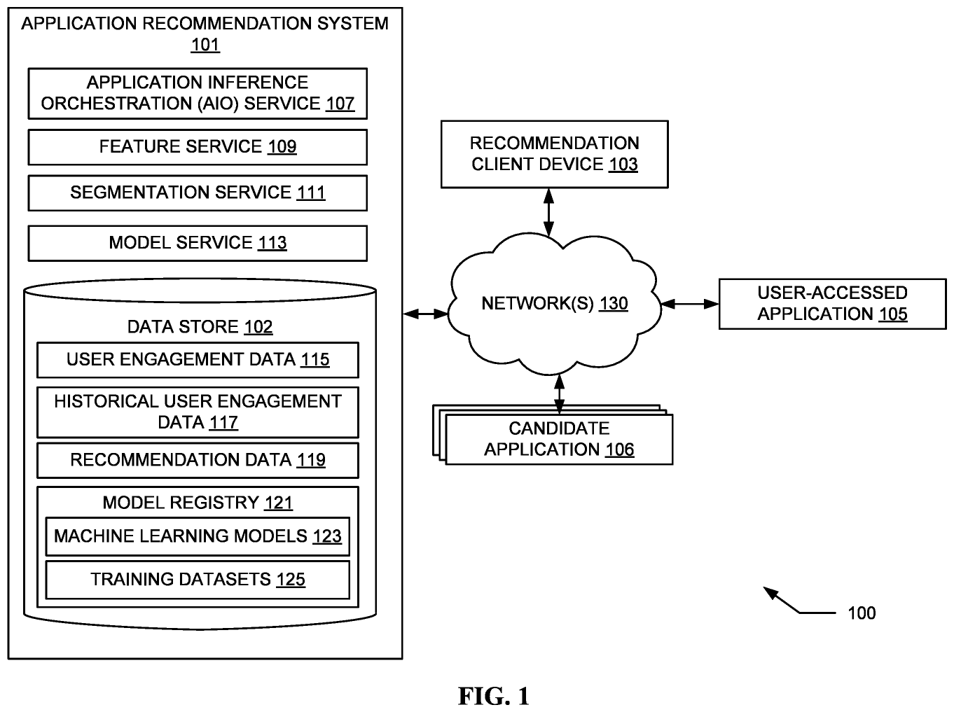

FIG. 1 illustrates an example network environment 100 within which embodiments of an application recommendation system may operate as described herein. In some embodiments, the network environment 100 includes an application recommendation system 101 configured to communicate with other elements of the network environment 100 via one or more networks 130. In some embodiments, other elements of the network environment 100 include one or more recommendation client devices 103, one or more user-accessed applications 105, and one or more candidate applications 106. In some embodiments, the application recommendation system 101 is configured to receive requests from the user-accessed application 105 to generate recommendations respective to a recommendation client device 103 of a particular entity (e.g., user-entity, domain-entity, and/or the like) and user engagement data 115 associated with the user-accessed application 105. In some embodiments, the application recommendation system 101 is configured to generate respective recommendation scores for a plurality of candidate applications 106 using a machine learning model and user engagement data associated with the particular entity. In some embodiments, the application recommendation system 101 is configured to train the machine learning model using historical user engagement data associated with one or more additional entities determined to be similar to the particular entity based on a similarity analysis of the particular entity's user engagement data and historical user engagement data corresponding to the additional entity. The application recommendation system 101 may store the trained machine learning model at the data store 102 in one or more model registries 121 to enable subsequent retrieval and use of the trained machine learning model to generate predictive output responsive to a recommendation request.

The recommendation client device 106 includes one or more computing device(s) accessible to an entity and configured to engage with applications, such as user-accessed applications 105 and candidate applications 106. In some embodiments, the recommendation client device 106 includes a personal computer, laptop, smartphone, tablet, Internet-of-Things enabled device, smart home device, virtual assistant, alarm system, workstation, work portal, and/or the like. The recommendation client device 106 may include one or more displays, one or more visual indicator(s), one or more audio indicator(s) and/or the like that enables output of information to the particular entity. For example, the application recommendation system 101 may cause provision of a recommendation to the recommendation client device 106, and the recommendation client device 106 may render the recommendation on the display. In some embodiments, the recommendation client device 106 includes one or more input devices 116 for receiving user inputs, such as commands to generate and transmit a change request data object. In some embodiments, the input device 116 includes one or more buttons, cursor devices, touch screens, including three-dimensional- or pressure-based touch screens, camera, fingerprint scanners, accelerometer, retinal scanner, gyroscope, magnetometer, and/or other input devices.

In some embodiment, the user-accessed application 105 manages privileges of entities to access application versions, levels of entitlement, application features, and/or the like. For example, the user-accessed application 105 may enable and disable an entity to access an application, application features, application versions, and/or the like via a user account and/or the recommendation client device 103. The user-accessed application 105 may facilitate performance of application actions, such as application purchases, application subscriptions, changes in application version, changes in application entitlement, and/or the like. In some embodiments, the user-accessed application 105 generates or receives data associated with interactions between an entity (or associated recommendation client device 103) and the user-accessed application 105. The user-accessed application 105 may provide the data to the application recommendation system 101 (e.g., or an external storage environment accessible to the application recommendation system 101) for storage as user engagement data 115 associated with the entity. In some embodiments, the user-accessed application 105 embodies a platform or portal accessible to the recommendation client device 103 and by which the recommendation client device 103 may perform application actions. For example, the user-accessed application 105 may include graphical user interfaces (GUIs) by which a user of a recommendation client device 103 may purchase and download a candidate application 106, upgrade between application versions or entitlement levels, and/or the like (e.g., in response to user input provide to the GUI via the recommendation client device 103). As another example, the user-accessed application 105 may render a GUI by which a user of a recommendation client device 103 may provide feedback to one or more rendered application recommendations, such as by providing user input for up-ranking, downranking, liking, or disliking a recommended application. The user-accessed application 105 may communicate with other services via the network 130 to perform the above-described functionality.

The user-accessed application 105 may receive recommendation data 119 from the application recommendation system 101 and provision recommendations to the recommendation client device 103. For example, the user-accessed application 105 may receive a plurality of recommendation scores and corresponding application identifiers from the application recommendation system 101. The user-accessed application 105 may generate a recommendation for a candidate application 106 associated with a highest recommendation score and provision the recommendation to the recommendation client device 103 of the particular entity for which the recommendation scores were generated. In another example, the user-accessed application 105 receives a recommendation generated by the application recommendation system 101 and a trigger event for provisioning the recommendation to a recommendation client device 103 of a particular entity (e.g., such as by rendering a GUI including the recommendation on a display). The user-accessed application 105 may determine that the trigger event has occurred or receive a signal indicative thereof from the application recommendation system 101. In response to the trigger event occurrence, the user-accessed application 105 may relay the recommendation to the recommendation client device 103.

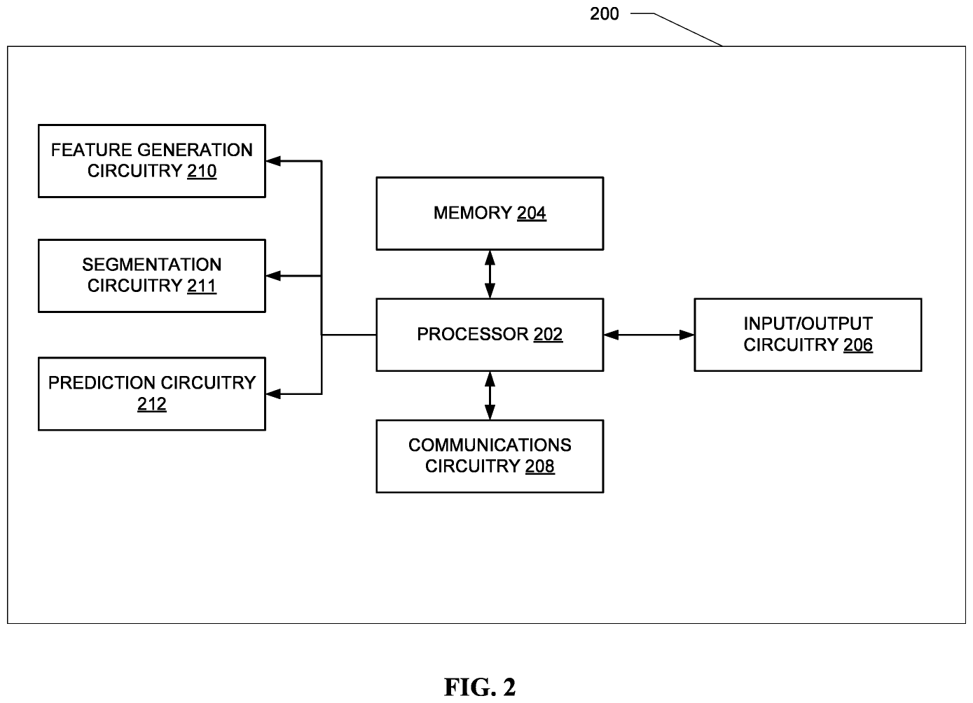

In some embodiments, the application recommendation system 101 is embodied as, or includes one or more, of a recommendation apparatus 200 (e.g., as further illustrated in FIG. 2 and described herein). Various applications and/or other functionality may be executed in the application recommendation system 101 and/or recommendation apparatus 200 according to various embodiments. In some embodiments, the application recommendation system 101 includes, but is not limited to, one or more data stores 102, an application inference orchestration (AIO) service 107, a feature service 109, a segmentation service 111, and a model service 113. The elements of the application recommendation system 101 can be provided via a plurality of computing devices that may be arranged, for example, in one or more server banks or computer banks or other arrangements. Such computing devices can be located in a single installation or may be distributed among many different geographical locations. For example, the application recommendation system 101 can include a plurality of computing devices that together may include a hosted computing resource, a grid computing resource, and/or any other distributed computing arrangement. In some cases, the application recommendation system 101 can correspond to an elastic computing resource where the allotted capacity of processing, network, storage, or other computing-related resources may vary over time.

In some embodiments, the application inference orchestration (AIO) service 107 is configured to receive and process recommendation requests and obtain data associated with generating responses to the recommendation requests. For example, the AIO service 107 may receive a recommendation request from the user-accessed application 105, the recommendation request including an entity identifier associated with a particular entity. The AIO service 107 may obtain data from a data store 102 based on the entity identifier, such as user engagement data 115 or historical user engagement data 117. In some embodiments, the recommendation request indicates a user-accessed application 105 associated with the particular entity. For example, the recommendation request includes an application identifier associated with the user-accessed application 105. The AIO service 107 may obtain user engagement data 115, historical user engagement data 117, and potentially other data from the data store based on the entity identifier, the application identifier, and/or the like.

In some embodiments, the AIO service 107 causes provision of recommendations to user-accessed applications 105 and/or recommendation client devices 103. For example, the AIO service 107 may provide a recommendation to a user-accessed application 105, which may cause the user-accessed application 105 to render a graphical user interface (GUI) including the recommendation on a display of recommendation client device 103. As another example, the AIO service 107 may provision the recommendation directly to the recommendation client device 103, such as by transmitting an email, push notification, text message, or other suitable electronic communication to the recommendation client device 103. In some embodiments, the recommendation indicates one or more candidate applications 106. In some embodiments, the recommendation indicates a respective recommendation score for one or more recommended applications. In some embodiments, the recommendation indicates one or more most-weighted or predictive features that contributed to a candidate application 106 being recommended to an entity (e.g., features, attributes, and/or the like that contributed to the recommendation score of the candidate application 106). In some embodiments, the AIO service 107 generates a report including recommendation scores and identifiers for corresponding candidate applications 106. The AIO service 107 may cause provision of the report to the user-accessed application 105 to enable the user-accessed application to determine one or more candidate applications to recommend to a particular entity (e.g., by generating and provisioning a recommendation to a recommendation client device 103 associated with the particular entity).

In some embodiments, the feature service 109 is configured to generate features values used as input to one or more machine learning models. For example, the feature service 109 may generate features based on historical user engagement data 117, the generated features being used to generate a training dataset for training a machine learning model to generate recommendation scores for candidate applications. As another example, the feature service 109 may generate features based on user engagement data 115 for use as input to a trained machine learning model for generating recommendation scores for a plurality of candidate applications 106. The feature service 109 may receive data for generating features from the AIO service 107, the data store 102, the user-accessed application 105, the recommendation client device 103, and/or the like. In some embodiments, the feature service 109 receives data for generating features from the segmentation service 111 or from other elements based on output from the segmentation service 111. For example, the segmentation service 111 may determine a subset of historical user engagement data 117 for use in training a machine learning model. The feature service 109 may obtain the subset of historical user engagement data from the segmentation service 111 or from the AIO service 107 and/or data store 102 based on the determination made by the segmentation service 111. In some embodiments, the feature service 109 includes or embodies a remote feature service that communicates with the application recommendation system 101 via one or more networks 130. The remote feature service may include user engagement data 115, historical user engagement data 117, and/or features derived from user engagement data 115 or historical user engagement data 117. For example, the remote feature service may include a data store including user engagement data, one or more corpuses of historical user engagement data, and/or features generated therefrom.

In some embodiments, features refer to data representations of independent variables, the values of which are used as input to machine learning models. Features may include categorical data representations, numerical data representations, array data representations, and/or the like. In some embodiments, the feature service 109 generates application features representative of interaction of an entity with an application. For example, the feature service 109 generates one or more application features based on user engagement data including one or more application actions, such as application purchase, application upgrade, application downgrade, application removal, and/or the like. As another example, feature service 109 generates one or more temporal features based on timing of one or more application actions indicated by the user engagement data, such as a time interval between application purchase and application upgrade, frequency of application use, duration of application use, time interval between application upgrade and application downgrade, and/or the like. Other examples of features generated by the feature service 109 include data representations derived from user demographics (e.g., age, location, role, experience level, and/or the like), domain demographics (e.g., industry, field, subfield, number of personnel, work volume, and/or the like), application features available to an entity, application features used or unused by the entity, and/or the like.

In some embodiments, the feature service 109 executes various techniques, algorithms, models, and/or the like, to generate feature values or other data representations of user engagement data by which feature values may be obtained. In some embodiments, the feature service 109 generates aggregate statistics based on user engagement data, such as mean, median, mode, standard deviation, arithmetic mean, geometric mean, harmonic mean, and/or the like. In some embodiments, the feature service 109 performs one or dimensionality reduction techniques to project user engagement data to a lower-level dimensional subspace. For example, the feature service 109 may execute techniques, algorithms, models, and/or the like for performing principal component analysis (PCA), partial least squares (PLS) regression, clustering, embedding, and/or the like. In some embodiments, the feature service 109 performs temporal or cohort-level aggregation techniques to aggregate user engagement data for subsequent treatment via one or more feature engineering techniques, algorithms, models, and/or the like.

In some embodiments, the feature service 109 performs one or more machine learning processes to model user engagement data, which may include the feature service 109 communicating with the model service 113 and/or model registry 121. In some embodiments, the feature service 109 performs deep learning techniques to model entity (or domain) behavior over time and extract or generate features that may provide greater entity behavior insight as compared to fixed-interval aggregations, such as descriptive statistics.

In some embodiments, the feature service 109 maps user engagement data to one or more use-cases, which may be associated with particular domain operation areas (e.g., information technology (IT) operations, IT services, customer success management (CSM), and/or the like) or particular products (e.g., applications, application versions, application features, levels of application entitlement, and/or the like). For example, the user engagement data 115 may include entity responses to one or more application usage surveys, which may include questions for determining motivations of application use, entity satisfaction, desired application features, and/or the like. The feature service 109 may map the survey data to use-cases (e.g., IT services, IT operations, CSM, etc.), where such mappings may be used as an additional input to generating application actions for the corresponding entity (e.g., or group of entities associated with the same or similar use-case or domain). As another example, the user engagement data 115 may include user projects (or descriptive data thereof) created by an entity via a user-accessed application. The feature service 109 may generate mappings of the user projects to one or more application use-cases. In some embodiments, the feature service 109 removes data noise by mapping user engagement data 115 to clean features that may be used by the model service 113. For example, the feature service 109 may map noisy job titles, team types, and/or the like to predefined feature values such that the information may be ingested into a machine learning model 123.

In some embodiments, the application recommendation system 101 includes a segmentation service 111 configured to segment historical user engagement data 117 based on determining associated entities that are similar to a particular entity (e.g., a target of predictive recommendation processes described herein). In some embodiments, the segmentation service 111 determines groups of similar users or domains that may be collectivized as a singular entity for which recommendations are generated. In various embodiments, the application recommendation system 101 generates recommendations for individual users, groups of users, individual domains, or groups of domains). For example, the segmentation service 111 may determine a group of users that are associated with the same project across one or more user-accessed applications 105 or the same instance of a particular user-accessed application 105, and the application recommendation system 101 may generate predictive output respective to an entity embodying the group of users.

In some embodiments, the segmentation service 111 is configured to determine one or more entities that are similar to a particular entity by performing one or more similarity analyses between user engagement data 115 associated with the particular entity and respective historical engagement data 117 associated with a plurality of additional entities. For example, the segmentation service 111 may determine a subset of additional entities that demonstrate a similar history of engagement with one or more user-accessed applications 105 and/or are associated with similar demographics to the particular entity. In some embodiments, the segmentation service 111 segments historical engagement data 117 based on the similarity analysis to obtain a subset of historical engagement data 117 that may be used by the model service 113 to generate predictive output, such as recommendation scores, trigger events, and/or the like. In some embodiments, a similarity analysis includes generating a similarity metric between two or more data points, such as a Euclidean distance, Manhattan distance, Chebychev distance, Minkowski distance, cosine similarity score, Pearson distance, Mahalanobis distance, standard error of difference (SED), Jaccard index, Levenshtein distance, Sorensen-Dice coefficient, Jensen-Shannon divergence, Canberra distance, Hamming distance, Spearman correlation, chi-square similarity, and/or the like.

In some embodiments, the application recommendation system 101 includes a model service 113 configured to generate, train, and execute machine learning models for generating various predictive outputs respective to a particular entity based on an input of user engagement data associated with the particular entity (e.g., or features derived from the user engagement data). The entity may be a particular end user of a user-accessed application 105, a group of users, or a domain. For example, the model service 113 may generate predictive output (e.g., recommendation scores, rankings, trigger events, and/or the like) for an entity embodying a group of users that are associated with the same project across one or more user-accessed applications 105 or the same instance (e.g., version, configuration, license agreement and/or the like) of a particular user-accessed application 105. As another example, the model service 113 may generate predictive output for an entity embodying a domain, where input data used by the model service 113 to generate the predictive output may include firmographic data associated with the domain and aggregated user engagement data from a plurality of end users associated with the domain.

In some contexts, the model service 113 may generate and train a first machine learning model 123 to generate respective recommendation scores for a plurality of candidate applications 106 based on user engagement data 115 associated with one or more user-accessed applications 105. The recommendation score may indicate a likelihood of a particular entity performing an application action respective to the candidate application 106 (e.g., purchasing the application, upgrading from a first version of the application to a second version of the application, utilizing a particular feature of the application, and/or the like). In some embodiments, the model service 113, or machine learning models 123, may generate and/or assign weight values to features used as input to recommendation generation processes, where the weight values may control a level of contribution of the feature value to the final predictive output of the model. For example, the model service 113 may assign greater weight values to data associated with a more recent time interval as compared to less recent data points. As another example, the model service 113 may assign lesser weights to application actions associated with no-cost application engagement, such as application trialing or download of a free version of an application. The model service 113 may assign greater weight values to application actions associated with premium application engagement, such as purchasing an application, upgrading an application, and/or the like. As still another example, the model service 113 may assign weights to various features based on the volume of underlying data used to generate the feature. In the context of features generated from collaboration data, the model service 113 may assign greater weight values in instances where the volume of cross-collaboration indicated by the collaboration data meets a predetermined threshold.

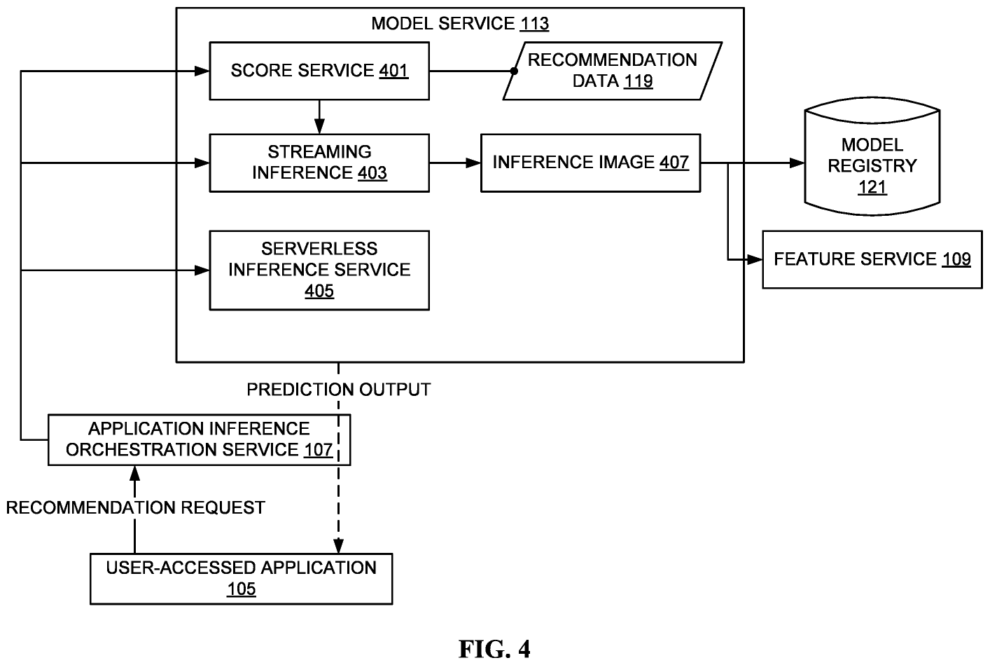

In another example, the model service 113 may generate and train a second machine learning model 123 to generate a trigger event for provisioning a recommendation to a recommendation client device 103 associated with a particular entity. The trigger event may include conditions, criteria, and/or the like that, upon detection or occurrence, cause the application recommendation system 101 to provision a recommendation for a candidate application 106 to a recommendation client device 103, or cause the application recommendation system 101 to instruct the user-accessed application 105 to provision the recommendation to the recommendation client device 103. The model service 113 may store machine learning models 123 in one or more model registries 121 and subsequently retrieve and use a stored machine learning model to generate predictive output, such as recommendation scores, trigger events, and/or the like. Further example aspects of the model service 113 are shown in FIG. 4 and described herein.

In some embodiments, the model service 113 is configured to generate recommendations for one or more candidate applications 106 based on recommendation scores generated by a machine learning model 123. For example, the model service 113 may process a plurality of recommendation scores, determine a candidate application 106 associated with a highest recommendation score, and generate a recommendation indicative of the candidate application 106 (e.g., for provision to a recommendation client device 103 or user-accessed application 105). In some embodiments, the model service 113 generates a recommendation including a commercial name of a candidate application 106 (e.g., which may be different from or identical to an internal identifier for the candidate application 106). In some embodiments, the model service 113 includes one or more language generation scripts, models, algorithms, and/or the like for generating recommendations including natural language.

In some embodiments, the application recommendation system 101 includes one or more data stores 102. The various data in the data store 102 may be accessible to elements of the application recommendation system 101, including the AIO service 107, feature service 109, segmentation service 111, model service 113, or an apparatus 200 embodying the one or more system elements. The data store 102 may be representative of a plurality of data stores 102 as can be appreciated. The data stored in the data store 102, for example, is associated with the operation of the various applications, apparatuses, and/or functional entities described herein. The data stored in the data store 102 may include, for example, user engagement data 115, historical user engagement data 117, recommendation data 118, and one or more model registries 121 including machine learning models 123 and training datasets 125. The data store 102 may include one or more storage units, such as multiple distributed storage units that are connected through a computer network. Each storage unit in the data store 102 may store at least one of one or more data assets and/or one or more data about the computed properties of one or more data assets. Moreover, each storage unit in the data store 102 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the network environment 100 includes a first data store 102 internal to the application recommendation system 101 and one or more additional data stores 102 that are external to the application recommendation system 101 and accessible by the application recommendation system 101 via one or more networks 130. The first data store 102 may include, for example, the recommendation data 119 and model registry 121, and the second data store 102 may include user engagement data 115 and historical user engagement data 117.

The user engagement data 115 may include one or more data objects associated with access or usage of an application by an entity. A set of user engagement data 115 may include an entity identifier for indicating the associated entity. The set of user engagement data 115 may include one or more application identifiers that indicate associations between the user engagement data 115 and one or more user-accessed applications 105. In some embodiments, the user engagement data 115 includes application actions, narratives descriptive of application actions, temporal features of application actions, domain associations, entitlement level associations, identifications of user-accessed applications (including individual functions, features, services, and/or the like within an application), indications of associations between applications (e.g., such as between a first user-accessed application that utilizes data from a second user-accessed application). In some embodiments, the user engagement data 115 includes timestamps corresponding to occurrences of application actions. In some embodiments, the user engagement data 115 includes durations of instances in which an entity engaged with a user-accessed application 105.

In some embodiments, the user engagement data 115 indicates a level of utilization of a user-accessed application. For example, the user engagement data 115 may indicate a utilization level including an amount of application resources utilized by an entity, such as a quantity of actions performed, amount of storage space utilized, application usage frequency, and/or the like. In some embodiments, the user engagement data includes demographic data associated with an entity, such as location, age, role, domain, industry, field, subfield, levels of entitlement to user-accessed applications 105, and/or the like. In some embodiments, the user engagement data 115 includes one or more application records associated with the entity and a user-accessed application 105. The application record may indicate historical application actions performed by or otherwise associated with an entity. For example, the user engagement data 115 may include an application action record including a time-series record of application actions respective to a user-accessed application 105 and associated with a particular entity.

In some embodiments, the user engagement data 115 includes configuration data for one or more user-accessed applications 105. The configuration data may include application settings, security requirements, user or administrator preferences, frequently used application features, and/or the like. In some embodiments, the user engagement data 115 includes firmographic data associated with one or more domains. For example, the user engagement data 115 includes domain name, domain size (e.g., number of personnel, revenue, growth, and/or the like), location, industry, subfield, customers, customer size, and/or the like. In some embodiments, the user engagement data 115 includes collaboration data indicative of in-application interactions between two or more entities. For example, the user engagement data 115 may include data associated with collaborative engagement between a first entity and a second entity with one or more user-access applications 105. In some contexts, the data associated with collaborative engagement may include temporal data for collaborative application usage, indications of application features utilized, and historical recommendation data 119 associated with either entity such that predictive output generated for one entity may be utilized as an input to generating predictive output respective to the other entity.

The historical user engagement data 117 may include user engagement data associated with a plurality of entities, user-accessed applications 105, and candidate applications 106. The historical user engagement data 117 may embody one or more corpuses of application actions, application records, demographic data, provisioned recommendations, and/or the like, associated with various entities and respective to various applications. For example, the historical user engagement data 117 may include a corpus of user engagement data associated with a plurality of entities and indicative of historical application actions initiated by the entities respective to one or more candidate applications 106, one or more user-accessed applications 105, and/or the like. The historical user engagement data 117 may include historical recommendations provisioned to entities. The historical user engagement data 117 may include associations between historical recommendations and subsequent application actions. For example, the historical user engagement data 117 may include an association between a historical recommendation for a particular candidate application 106 (e.g., including date of the recommendation, means of provision, trigger event, and/or the like) and any subsequent application action initiated by the associated entity respective to the particular candidate application 106. The subsequent application action may indicate, for example, whether the entity purchased the candidate application 106 or upgraded their level of entitlement or application version corresponding to the recommendation. In some embodiments, the feature service 109, segmentation service 111, and/or model service 113 generate training datasets 125 for training machine learning models 123 based on one or more subsets of the historical engagement data 117 (e.g., the subset being associated with entities determined to be similar to a target entity for which a recommendation will be generated by the trained machine learning model).

For example, the feature service 109 may generate a plurality of application features and temporal features based on historical engagement data 117 associated with a plurality of entities, one or more user-accessed applications 105, and a plurality of candidate applications 106. The segmentation service 111 may perform a similarity analysis between the application features and temporal features of the historical engagement data and corresponding features derived from user engagement data 115 of a target entity to determine a subset of the plurality of entities that demonstrate a threshold-satisfying similarity to the target entity. The model service 113 may generate a training dataset 125 including a subset of the application features and temporal features associated with the determined subset of the plurality of entities. The model service 113 may train a machine learning model 123 to generate recommendation scores for the plurality of candidate applications 106.

The recommendation data 119 includes any data associated with predictive processes performed by machine learning models 123 including recommendation scores, trigger events, and/or the like. The recommendation data 119 may include one or more rankings of candidate applications 106, where the ranking is generated by the model service 113 based on respective recommendation scores for a plurality of candidate applications 106 (e.g., a top-ranked entry of the ranking corresponding to a candidate application associated with a highest recommendation score from a set of recommendation scores). In some embodiments, the recommendation data 119 includes metadata associated with generation of recommendation scores, trigger events, and/or the like. For example, the metadata may include a timestamp of score or trigger event generation. As another example, the metadata may include identifiers for one or more machine learning models 123 used to generate the corresponding recommendation scores or trigger event. As another example, the metadata may include an entity identifier associated with a target entity for which predictive output (e.g., recommendation scores, trigger events, and/or the like) was generated by the one or more machine learning models. In still another example, the metadata may include associations between predictive output, one or more machine learning models 123 that generated the output, and one or more training datasets 125 used to train the machine learning models 123.

The model registry 121 includes machine learning models 123 and training datasets 125 for training and validating the machine learning models 123. The model registry 121 may include model identifiers for tracking and identifying machine learning models 123. The model registry 121 may store associations between model identifiers and entity identifiers, application identifiers, domain identifiers, and/or the like to enable retrieval of appropriately trained models responsive to recommendation requests associated with a particular user-accessed application 105, entity, domain, and/or the like. The model registry 121 may include machine learning models 123 that are associated with generating predictive output respective to different application and/or different entity aspects (e.g., entitlement level, domain-related factors, demographic-related factors, and/or the like). For example, the model registry may include (i) a first machine learning model 123 trained to generate predictive output respective to a first set of candidate applications 106 and/or user engagement data 115 associated a first user-accessed application 105, and (ii) a second machine learning model 123 trained to generate predictive output respective to a second set of candidate applications 106 and/or user engagement data 115 associated a second user-accessed application 105. As another example, the model registry may include a first machine learning model 123 trained using a corpus of historical user engagement data 117 for entities associated with a first domain and a second machine learning model 123 trained using a corpus of historical user engagement data 117 for a second domain. The various specially configured machine learning models 123 may be selectively used by the model service 113 to generate predictive output based on aspects of a target entity, one or more user-accessed applications 105 associated with the target entity, or a target set of candidate applications 106 (e.g., such as a set of applications utilized by additional entities determined to demonstrate threshold-satisfying similarity to the target entity).

For example, the model registry 121 may include a first machine learning model 123 configured to generate predictive output respective to a first set of candidate applications 106 that are associated with the same application provider (e.g., first-party applications). The model registry 121 may further include a second machine learning model 123 configured to generate predictive output corresponding to a second set of candidate applications 106 that integrate with the first set of candidate applications 106 but are not owned by the same application provider (e.g., second-party applications). The model registry 121 may further include a third machine learning model 123 configured to generate predictive output corresponding to a third set of candidate applications 106 that are not specifically configured to integrate with the first set of candidate applications 106 and are not owned by the same application provider (e.g., third-party applications). In some contexts, the first, second, and third machine learning models 123 may be trained using training datasets 125 that comprise historical user engagement data 117 associated with the corresponding set of first-, second-, or third-party candidate applications 106.

The model registry 121 may include training datasets 125 for training machine learning models 123 to generate predictive output, such as recommendation scores or trigger events. In some embodiments, a training dataset 125 includes historical user engagement data 117 or features generated from historical user engagement data 117. For example, a training dataset 125 may include features generated based on a corpus of historical user engagement data 117 associated with a plurality of entities and interaction of the plurality of entities with one or more user-accessed applications 105 and/or candidate applications 106. In some contexts, a training dataset 125 may indicate current or historical user-accessed applications 105 that received engagement from one or more entities (e.g., signup, evaluation, purchase, and/or the like from a user or domain administrator). In some embodiments, the training dataset 125 includes firmographic data corresponding to one or more domains with which an entity represented in the training dataset is associated. In some embodiments, the training dataset 125 includes historical application activity and usage data and/or patterns related to user-accessed applications 105 of one or more entities. In some embodiments, the training dataset 125 indicates one or more marketing channels by which recommendations and/or the like were provided to an entity. In some embodiments, the training dataset 125 includes touchpoint data for historical communications provisioned to an entity. For example, the touchpoint data may include time of contact, means of contact, frequency of communication, communication composition, and/or the like. In some embodiments, the training dataset 125 includes onboarding-related data, such as security policies or application setting preferences for entities associated with a particular domain or industry. As another example, onboarding-related data may include responses to application surveys and/or the like for identifying user or domain needs. In some embodiments, the training dataset 125 includes search engine-related data, such as a sequence of keyword searches associated with one or more applications or a relevancy metric indicative of how a particular application is returned in a search result (e.g., search ranking, relevancy, and/or the like). In some embodiments, the training dataset 125 includes associations between historical user-accessed applications 105 of a respective entity such that co-ownership of applications and impacts thereof on application recommendations may be represented in the training data.

In some embodiments, the training dataset 125 includes outcomes of historical recommendations provisioned to entities. For example, a training dataset 125 may include historical recommendations for purchasing a candidate application 106 and respective application records for a plurality of entities to which the historical recommendations were provisioned. The respective application record may indicate whether the corresponding entity purchased the recommended candidate application 106, which may improve training of a machine learning model 123 to better predict candidate applications with which other entities are most likely to engage. As another example a training dataset 125 may include historical trigger events utilized to initiate provision of a recommendation for upgrading an application to one or more entities. The training dataset 125 may further include respective application records indicative of whether the corresponding entity performed the upgrade application action within a predetermined time interval of receiving the recommendation, which may improve training of a machine learning model 123 to better predict optimal trigger events for provisioning a recommendation for the same application action to other entities.

In some embodiments, a training dataset 125 includes historical recommendations provisioned to entities. The recommendation may indicate, for example, the candidate application 106 being recommended, a recommended version or edition of the candidate application, and a level of entitlement to the candidate application recommended for the entity. In some embodiments, the training dataset 125 includes a filtered subset of historical user engagement data 117 obtained from the segmentation service 111. For example, the training dataset 125 may include a filtered subset of historical user engagement data 117 that is associated with entities that purchased an application (or performed another suitable application action) and demonstrated engagement with the application within a predetermined interval of the purchase. As another example, the filtered subset of historical user engagement data 117 may include data associated with entities that upgraded an application to a particular version, such as a premium or enterprise version, and may exclude data associated with entities that upgraded or downgraded an application to another particular version, such as from a free version to a standard version or from a premium or enterprise version to a standard version or free version.

In some embodiments, the model registry 121 includes different training datasets 125 that correspond to different entity archetypes. The entity archetypes may be based on entity role (e.g., technical role, formal job title, and/or the like), type of entity activity (e.g., development contributor, team organizer, quality assurance engineer, etc.), level of application engagement (e.g., dormant, low, medium, high), and/or the like. For example, the model registry 121 may include a first training dataset 125 for use in training machine learning models 123 associated with low-engagement entities and a second training dataset 125 for use in training machine learning models 123 associated with high-engagement entities. The first and second training datasets 125 may be generated based on historical user engagement data 117 associated with the corresponding engagement level.

In some embodiments, the model service 113 updates a training dataset 125 based on user engagement data 115 obtained following provision of a recommendation to a particular entity. For example, following provision of a recommendation for a candidate application to a particular entity, the AIO service 107 obtains additional user engagement data 115 from user-accessed applications 105 (e.g., potentially including candidate applications that subsequently received user engagement) and/or associated recommendation client device 103. The feature service 109 may generate additional features based on the user engagement data 115 and the model service 113 may update a training dataset 125 associated with the particular entity and recommendation based on the additional features.

The network 130 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the network 130 may include a cellular telephone, an 802.11, 802.16, 802.20, and/or WiMax network. Further, the network 130 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. For instance, the networking protocol may be customized to suit the needs of a group-based communication system. In some embodiments, the protocol is a custom protocol of JavaScript Object Notation (JSON) objects sent via a Websocket channel. In some embodiments, the protocol is JSON over RPC, JSON over REST/HTTP, and the like.

### Exemplary Apparatus

The application recommendation system 101 may be embodied by one or more computing systems, such as apparatus 200 shown in FIG. 2. The apparatus 200 may include processor 202, memory 204, input/output circuitry 206, communications circuitry 208, feature generation circuitry 210, segmentation circuitry 211, and prediction circuitry 212. The apparatus 200 may be configured to execute the operations described herein. Although these components 202-212 are described with respect to functional limitations, it should be understood that the particular implementations necessarily include the use of particular hardware. It should also be understood that certain of these components 202-212 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present disclosure.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the algorithms and/or operations described herein when the instructions are executed.

In some embodiments, the apparatus 200 may include input/output circuitry 206 that may, in turn, be in communication with processor 202 to provide output to the user and, in some embodiments, to receive an indication of a user input. The input/output circuitry 206 may include a user interface and may include a display, and may include a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry including the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communications circuitry 208 may include the circuitry for interacting with the antenna/antennae to cause transmission of signals via the antenna/antennae or to handle receipt of signals received via the antenna/antennae. In some embodiments, the communications circuitry 208 performs functionality of the application inference orchestration (AIO) service. For example, the communications circuitry 208 includes one or more application programming interfaces (APIs) configured to enable the apparatus 200 to receive recommendation requests from the user-accessed application 105, provision predictive outputs to the user-accessed application 105 (e.g., recommendation scores, trigger events, recommendations, and/or the like), and obtain user engagement data from sources external to the apparatus 200.

The feature generation circuitry 210 may be any means such as a device or circuitry embodied in either hardware or a combination of hardware and software that is configured to generate features based on user engagement data 115. The feature generation circuitry 210 may embody functionality of the feature service 109. For example, the feature generation circuitry 210 may generate a feature indicative of user engagement level with an application during a particular interval, such as whether an entity engaged with an application within 1 days, 2 days, 1 week, or any suitable interval following purchase of an application or upgrade of the application from a first version to a second version. As another example, the feature generation circuitry may generate a feature indicative of level of utilization of a particular application function by an entity.

The segmentation circuitry 211 may be any means such as a device or circuitry embodied in either hardware or a combination of hardware and software that is configured to perform similarity analyses and segmentation operations on user engagement data 115, historical engagement data 117, and/or the like. The segmentation circuitry 211 may embody functionality of the segmentation service 211. In some embodiments, the segmentation circuitry 211 determines one or more entities that are similar to a target entity by performing similarity analyses between user engagement data 115 and historical user engagement data 117. The segmentation circuitry 211 may generate subsets of historical user engagement data 117 based on similarity analyses.

The prediction circuitry 212 may be any means such as a device or circuitry embodied in either hardware or a combination of hardware and software that is configured to generate, train, and execute machine learning models 123 to generate predictive output, such as recommendation scores or trigger events. For example, the prediction circuitry 212 may be configured to generate and train a machine learning model 123 to generate a respective recommendation score for a plurality of candidate applications 106 based on user engagement data 115 associated with a particular entity and one or more user-accessed applications 105. As another example, the prediction circuitry 212 may be configured to generate and train a machine learning model 123 to generate an optimal trigger event for provisioning a recommendation for a candidate application 106 to a target entity.

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

### Exemplary Recommendation Client Device

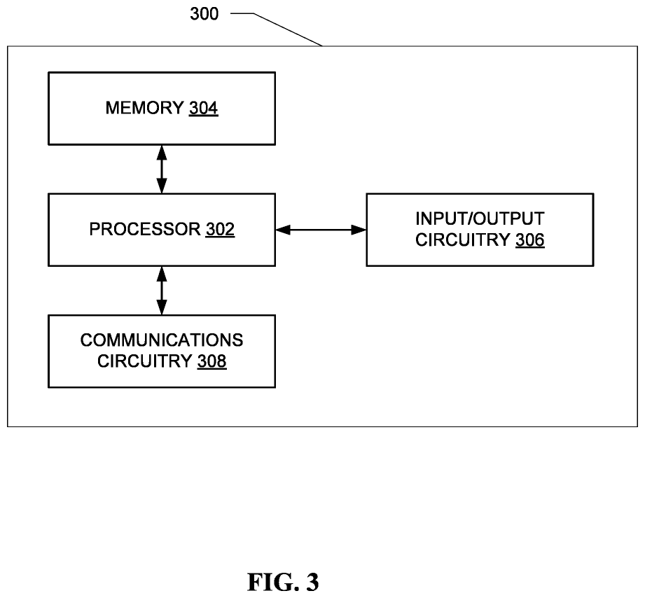

Referring now to FIG. 3, the recommendation client device 103 may be embodied by one or more computing systems, such as apparatus 300 shown in FIG. 3. The apparatus 300 may include processor 302, memory 304, input/output circuitry 306, and communications circuitry 308. Although these components 302-308 are described with respect to functional limitations, it should be understood that the particular implementations necessarily include the use of particular hardware. It should also be understood that certain of these components 302-308 may include similar or common hardware. For example, two sets of circuitries may both leverage use of the same processor, network interface, storage medium, or the like to perform their associated functions, such that duplicate hardware is not required for each set of circuitries.

In some embodiments, the processor 302 (and/or co-processor or any other processing circuitry assisting or otherwise associated with the processor) may be in communication with the memory 304 via a bus for passing information among components of the apparatus. The memory 304 is non-transitory and may include, for example, one or more volatile and/or non-volatile memories. In other words, for example, the memory 304 may be an electronic storage device (e.g., a computer-readable storage medium). The memory 304 may include one or more databases. Furthermore, the memory 304 may be configured to store information, data, content, applications, instructions, or the like for enabling the apparatus 300 to carry out various functions in accordance with example embodiments of the present disclosure.

The processor 302 may be embodied in a number of different ways and may, for example, include one or more processing devices configured to perform independently. In some preferred and non-limiting embodiments, the processor 302 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 302 may be configured to execute instructions stored in the memory 304 or otherwise accessible to the processor 302. In some preferred and non-limiting embodiments, the processor 302 may be configured to execute hard-coded functionalities. As such, whether configured by hardware or software methods, or by a combination thereof, the processor 302 may represent an entity (e.g., physically embodied in circuitry) capable of performing operations according to an embodiment of the present disclosure while configured accordingly. Alternatively, as another example, when the processor 302 is embodied as an executor of software instructions (e.g., computer program instructions), the instructions may specifically configure the processor 302 to perform the algorithms and/or operations described herein when the instructions are executed. The apparatus 300 may execute or otherwise engage with applications using the processor 302, input/output circuitry 306, and, in some embodiments, the communications circuitry 308. For example, the apparatus 300 may provide inputs to and receive output from one or more user-accessed applications 105 or candidate applications 106.

In some embodiments, the apparatus 300 may include input/output circuitry 306 that may, in turn, be in communication with processor 302 to provide output to the user and, in some embodiments, to receive an indication of a user input. The input/output circuitry 306 may include a user interface and may include a display, and may include a web user interface, a mobile application, a query-initiating computing device, a kiosk, or the like. In some embodiments, the input/output circuitry 306 may also include a keyboard (e.g., also referred to herein as keypad), a mouse, a joystick, a touch screen, touch areas, soft keys, a microphone, a speaker, or other input/output mechanisms. The processor and/or user interface circuitry including the processor may be configured to control one or more functions of one or more user interface elements through computer program instructions (e.g., software and/or firmware) stored on a memory accessible to the processor (e.g., memory 304, and/or the like).

The communications circuitry 308 may be any means such as a device or circuitry embodied in either hardware or a combination of hardware and software that is configured to receive and/or transmit data from/to a network and/or any other device, circuitry, or module in communication with the apparatus 300. In this regard, the communications circuitry 308 may include, for example, a network interface for enabling communications with a wired or wireless communication network. For example, the communications circuitry 308 may include one or more network interface cards, antennae, buses, switches, routers, modems, and supporting hardware and/or software, or any other device suitable for enabling communications via a network. Additionally, or alternatively, the communications circuitry 308 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 300. In some embodiments, one or more external systems (such as a remote cloud computing and/or data storage system) may also be leveraged to provide at least some of the functionality discussed herein.

### Exemplary Model Service

Referring now to FIG. 4, in some embodiments, the model service 113 includes various internal or remote services configured to perform real-time (e.g., synchronous) or event-driven (e.g., asynchronous) prediction operations. In some embodiments, the model service 113 includes a score service 401, streaming inference 403, serverless inference service 405, and an inference image 407. In some embodiments, the score service 401 enables the user-accessed application 105 to request and receive stored recommendation scores and other recommendation data 119 from the application recommendation system 101. For example, the score service 401 may embody a hypertext transfer protocol (HTTP) service that receives from the user-accessed application 105 a request for stored recommendation scores, the request including one or more entity identifiers, one or more application identifiers, one or more domain identifiers, and/or the like. Based on the request, the score service 401 may retrieve one or more stored recommendation scores and cause provision of the recommendation scores to the user-accessed application 105. In some embodiments, as recommendation scores are generated, the score service 401 streams the recommendation stores to one or more data stores for later retrieval.

In some embodiments, the streaming inference 403 is an event-driven interface for inference (e.g., predicting recommendation scores, trigger events, and/or the like). The streaming inference 403 may enable the user-accessed application 105 to provide recommendation requests via an event stream producer and/or initiate actions based on recommendation scores and/or trigger events via an event stream consumer. For example, the streaming inference 403 may enable the model service 113 to receive recommendation requests from the user-accessed application 105 via an event stream producer and the AIO service 107. As another example, the streaming inference 403 may enable the model service 113 to provide responses to recommendation requests to the user-accessed application 105 via the AIO service 107. In another example, the streaming inference 403 may enable the user-accessed application 105 to perform actions respective to recommendation scores (or other predictive output, such as trigger events) via an event stream consumer, such as monitoring for trigger events, initiating provision of recommendations, and/or the like.

In some embodiments, the serverless inference service 405 is a prediction service built on serverless architecture and configured to generate and execute machine learning models to generate predictive output on a real-time, synchronous basis. For example, the serverless inference service 405 may be a recommendation score generation service in which functionality for generating, training, and executing machine learning models is provided by a remote cloud environment on an on-demand basis (e.g., embodying a function as a service (FaaS) platform). In some embodiments, the inference image 407 is a base image used for generating machine learning models of any suitable model type. The inference image 407 may be an efficient base image for machine learning models to enable large-scale prediction operations with minimal latency, minimal boot time, and/or optimal runtime performance.

### Example Data Flows and Operations

To address some of the efficiency-related shortcomings of various existing approaches to improving application utilization and engagement, various embodiments of the present disclosure disclose techniques for generating predictive measures for determining and recommending candidate applications most likely to be utilized by an entity based on current and historical user engagement data for one or more applications. For example, in some embodiments, an application recommendation system receives, from at least one data store, user engagement data associated with at least one user-accessed application, where the user engagement data is associated with an entity identifier of a particular entity; receives, from the at least one data store, a corpus of historical user engagement data associated with a plurality of additional entities, where respective entities of the plurality of additional entities are associated with the at least one user-accessed application and at least one of a plurality of candidate applications; determines a subset of the plurality of additional entities associated with the particular entity by performing a similarity analysis between the user engagement data and the corpus of historical user engagement data; generates, using a machine learning model, respective recommendation scores for the plurality of candidate applications based on the user engagement data, where: the machine learning model was previously trained using a subset of the corpus of historical user engagement data corresponding to the subset of the plurality of additional entities; and the recommendation score indicates a likelihood of the particular entity performing at least one application action respective to the corresponding candidate application; generates a recommendation for the particular entity based on the respective recommendation scores, where the recommendation indicates at least one of the plurality of candidate applications; and causes provision of the recommendation to the user-accessed application, where the user-accessed application causes provision of the recommendation to a computing device associated with the entity identifier.

By utilizing the noted techniques for determining candidate applications with which an entity is most likely to engage, various embodiments of the present disclosure incorporate predictive signals that indicate a predicted likelihood of the entity to engage with a candidate application or a particular version or feature of a candidate application. In doing so, the noted embodiments of the present disclosure can optimize the provision of application recommendations to a computing device and improve application utilization by identifying and indicating applications most likely to satisfy needs and interests of the entity, thereby increasing user engagement. By improving the identification of applications, application versions, application features, and/or the like that are most likely to receive engagement from an entity, the described embodiments of the present disclosure enhance computational efficiency of generating and serving application recommendations within user-accessed applications. Accordingly, various embodiments of the present disclosure improve computational efficiency of application recommendation and engagement improvement processes.

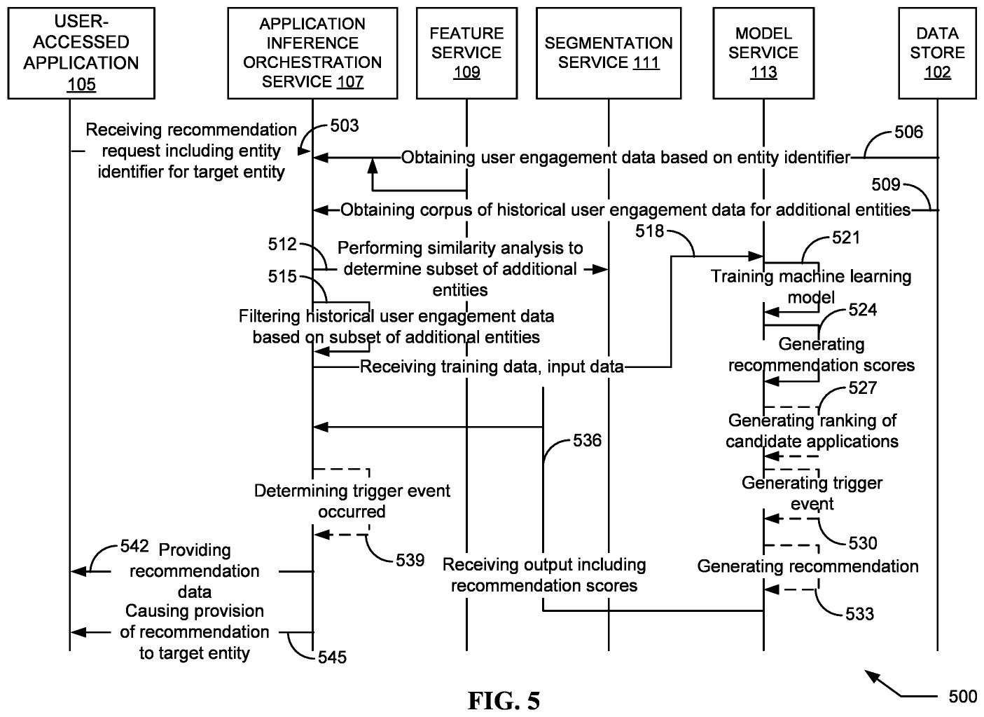

FIG. 5 is a cross-functional diagram of an example workflow 500 for improving application utilization using predictive recommendations generated by a specially configured application recommendation system in accordance with at least some embodiments of the present disclosure. The workflow 500 may be performed by various elements of the application recommendation system 101 including the application inference orchestration (AIO) service 107, feature service 109, segmentation service 111, model service 113, and data store 102.

In some embodiments, the workflow 500 includes the AIO service 107 receiving a recommendation request from the user-accessed application 105 (indicium 503). The recommendation request may include an entity identifier for a target entity such that user engagement data associated with the target entity may be obtained based on the entity identifier. In some embodiments, the recommendation request includes additional identifiers for retrieving and filtering data associated with the target entity, such as an application identifier for a user-accessed application or a domain identifier for a domain with which the target entity is associated. In some embodiments, the workflow 500 includes the AIO service 107 obtaining user engagement data 115 from the data store 102 and/or feature service 109 based on the entity identifier (e.g., and potentially other identifiers) (indicium 506).

In some embodiments, the workflow 500 includes the AIO service 107 obtaining one or more corpuses of historical engagement data 117 for additional entities from the data store 102 (indicium 509). In some embodiments, based on the recommendation request of indicium 503 and/or user engagement data 115 of indicium 506, the AIO service 107 may determine one or more sets of historical engagement data 117 to obtain from the data store 102. For example, the recommendation request may include identifiers for a plurality of candidate applications and one or more user-accessed applications, and the AIO service 107 may obtain historical user engagement data 117 from the data store 102 based on the various identifiers. As another example, the recommendation request may include a domain identifier associated with the particular entity or entity identifier (e.g., or the AIO service may determine the domain identifier based on the entity identifier), and the AIO service 107 may obtain historical user engagement data 117 for additional entities that are associated with the same domain identifier or identifiers for similar domains.

In some embodiments, the user engagement data 115 of indicium 503 or historical engagement data 117 of indicium 509 may be processed by the feature service 109 to generate features based upon which subsequent operations of the workflow 500 may be performed. For example, the similarity analysis of indicium 512 may be performed using respective features derived from the user engagement data 115 or historical user engagement data 117.

In some embodiments, the workflow 500 includes the segmentation service 111 performing a similarity analysis between the user engagement data 115 and historical user engagement data 117 (or features derived therefrom by the feature service 109) to determine a subset of the additional entities that demonstrate a threshold-satisfying similarity to the target entity indicated by the recommendation request (indicium 512). In some embodiments, the workflow 500 includes the AIO service 107 and/or segmentation service 111 filtering the corpus of historical user engagement data of indicium 509 based on the similarity analysis to obtain a subset of historical user engagement data corresponding to the subset of additional entities determined to be similar to the target entity (indicium 515).

In some embodiments, the workflow 500 includes the model service 113 receiving input data including the user engagement data 115 of indicium 506 and training data including the subset of historical engagement data 117 of indicium 515 (indicium 518). In some embodiments, the model service 113 generates or updates one or more training datasets 125 based on the subset of historical engagement data 117. In some embodiments, the model service 113 receives one or more identifiers based upon which the model service 113 may retrieve or initialize a stored machine learning model 123 or training dataset 125.

In some embodiments, the workflow 500 includes the model service 113 generating and training a machine learning model 123 to generate predictive output for a plurality of candidate applications 106 using one or more training datasets 125 (indicium 521). Alternatively, or additionally, in some embodiments, the model service 113 retrieves a stored machine learning model 123 from a model registry 121 based on one or more received or determined identifiers associated with the recommendation request, such as an entity identifier, application identifier, domain identifier, and/or the like. The generation and training of the machine learning model 123 may occur prior to other operations of the workflow 500. For example, generation and training of the machine learning model 123 may be performed prior to receipt of the recommendation request (indicium 503). The model service 113 may previously train the machine learning model 123 using one or more training datasets 125 including the subset of historical engagement data 117 and, in some embodiments, user engagement data 115. For example, the model service 113 may train a first machine learning model to generate recommendation scores for a plurality of candidate applications 106 and a second machine learning model to generate a trigger event for provisioning a recommendation for one or more of the candidate applications 106.

In some embodiments, the workflow 500 includes the model service 113 generating respective recommendation scores for the plurality of candidate applications 106 based on the trained machine learning model and the user engagement data 115 associated with the target entity (indicium 524). In some embodiments, the model service 113 stores the recommendation scores at the data store 102. In some embodiments, the model service 113 compares the recommendation scores to one or more predetermined score thresholds to determine whether the corresponding candidate application 106 qualifies for recommendation to the target entity. In some embodiments, the workflow 500 optionally includes the model service 113 generating a ranking of the plurality of candidate applications 106 based on the recommendation scores (indicium 527). The model service 113 may generate a ranking of a subset of the plurality of candidate applications 106 for which the corresponding recommendation score meets a predetermined score threshold. In some embodiments, the model service 113 may determine and indicate to the AIO service 107 one or more features that most heavily contribute to the recommendation score of a candidate application 106.

In some embodiments, the workflow 500 optionally includes the model service 113 using a second machine learning model 123 and the user engagement data 115 to generate a trigger event for provisioning a recommendation for one or more candidate applications 106 to the target entity (indicium 530). For example, the model service 113 may generate a trigger event for provisioning a recommendation for a candidate application 106 associated with a highest recommendation score. As another example, the model service 113 may generate a respective trigger event (or a collective trigger event) for provisioning a recommendation for a plurality of candidate applications for which the corresponding recommendation score meets a predetermined threshold.

In some embodiments, the workflow 500 optionally includes the model service 113 generating a recommendation for one or more candidate applications (indicium 533). For example, the model service 113 may generate the recommendation using a machine learning model 123, such as a model configured to generate a natural language output based on an input including entity information (e.g., identifier, username, associated domain, and/or the like) and candidate application information (e.g., identifier, product name, version, level of entitlement, and/or the like). In some embodiments, the recommendation includes natural language that indicates one or more recommended candidate applications 106. The recommendation may further include a recommended application version and/or level of entitlement. In some embodiments, the recommendation includes one or more top features that contributed to generation of the recommendation or to a recommendation score for a candidate application 106 indicated by the recommendation. For example, the recommendation may indicate that a particular candidate application 106 is being recommended to an entity based on a technical role of the entity, application activity of the entity in a current user-access application 105, a domain with which the entity is associated, and/or cross-engagement between the entity and one or more additional entities associated with the same domain. The top features may correspond to the most heavily weighted features and/or most predictive features utilized by a machine learning model 123 to generate a recommendation score for a candidate application 106.

In some embodiments, the workflow 500 includes the AIO service 107 receiving output from the model service 113, the output including one or more recommendation scores, trigger events, and/or the like (indicium 539). In some embodiments, the AIO service 107 receives a subset of recommendation scores determined by the model service 113 to meet a predetermined score threshold. In some embodiments, the output includes respective application identifiers associated with the recommendation scores. In some embodiments, the output indicates one or more recommended candidate applications 106, a recommended version of the recommended candidate application 106, and a recommended level of entitlement of the target entity to the recommended candidate application 106. In some embodiments, the AIO service 107 receives a ranking of a plurality of candidate applications 106 in which the ordering of entries in the ranking is based on ascending or descending recommendation score. In some embodiments, the AIO service 107 receives a trigger event for provisioning a recommendation and configures one or more monitoring services to monitor for occurrence of the trigger event.

In some embodiments, the workflow 500 optionally includes the AIO service 107 determining whether a trigger event for provisioning a recommendation has occurred (indicium 539). For example, the AIO service 107 may determine that the target entity has performed a particular application action respective to a user-accessed application 105, that a predetermined time interval has elapsed, and/or that the target entity has reached a predetermined utilization level for the user-accessed application 105. In response to the determination, the AIO service 107 may cause the user-accessed application 105 to provision a recommendation for one or more candidate applications 106 to a recommendation client device 103 of the target entity.

In some embodiments, the workflow 500 includes the AIO service 107 providing recommendation data 119 to the user-accessed application 105 (indicium 542). The recommendation data 119 may include one or more recommendation scores, one or more rankings of candidate applications 106, identifiers for one or more candidate applications 106 (e.g., such as high-scoring candidate applications 106), trigger events, draft recommendation communications, and/or the like. For example, the AIO service 107 may provide to the user-accessed application 105 one or more application identifiers and recommendation scores associated with candidate applications 106 for which the corresponding recommendation score meets a predetermined score threshold. In some embodiments, the AIO service 107 indicates one or more recommended candidate applications 106 including information that identifies the candidate application 106, a recommended version, and a recommended level of entitlement.

In some embodiments, the workflow 500 includes the AIO service 107 causing the user-accessed application 105 to provision one or more recommendations to the target entity (indicium 545). For example, in response to the AIO service 107 providing the recommendation data 119 to the user-accessed application 105, the AIO service 107 may automatically trigger the user-accessed application 105 to provision a recommendation for one or more candidate applications 106 to a recommendation client device 103 associated with the target entity. The AIO service 107 may cause the user-accessed application 105 to render a graphical user interface (GUI) on a display of the recommendation client device 103 including the recommendation for the candidate application 106. In some embodiments, the GUI includes user input fields that enable a user to provide feedback to the recommendation via inputs to the recommendation client device 103. For example, the GUI may include user input fields by which a user may up-rank, downrank, like, or dislike one or more recommended candidate applications 106. In some embodiments, the AIO service 107 receives user feedback inputted to the recommendation client device and provides the data to the model service 113 for model training purposes. Alternatively, or additionally, the AIO service 107 may determine whether a trigger event has occurred and, in response to determining the trigger event has occurred, instruct the user-accessed application 105 to provision the recommendation to the recommendation client device 103.

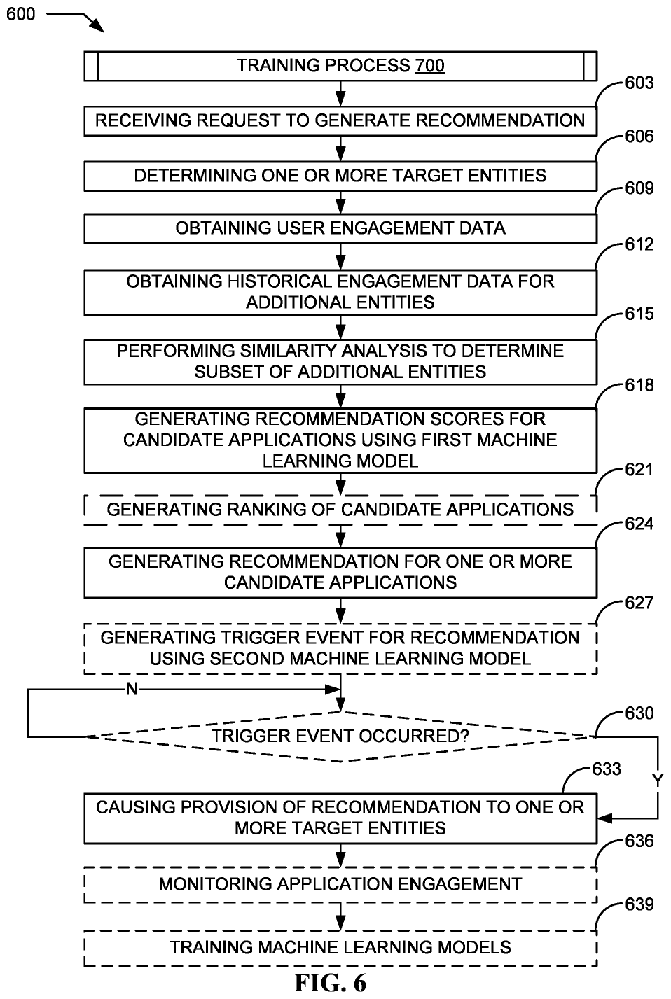

FIG. 6 is a flowchart diagram of an example recommendation generation process 600 for generating an application recommendation using one or more machine learning models in accordance with at least some embodiments of the present disclosure. The process 600 may be performed by various embodiments of the application recommendation system 101 shown in FIG. 1 and described herein. For example, the process 600 may be performed by an apparatus 200 that embodies functionality of the application recommendation system 101 described herein. In some embodiments, via various operations of the process 600, the application recommendation system 101 may improve application utilization and engagement by leveraging user engagement data to train and execute machine learning models for predicting candidate applications (or application features) most likely to receive engagement from a particular entity.

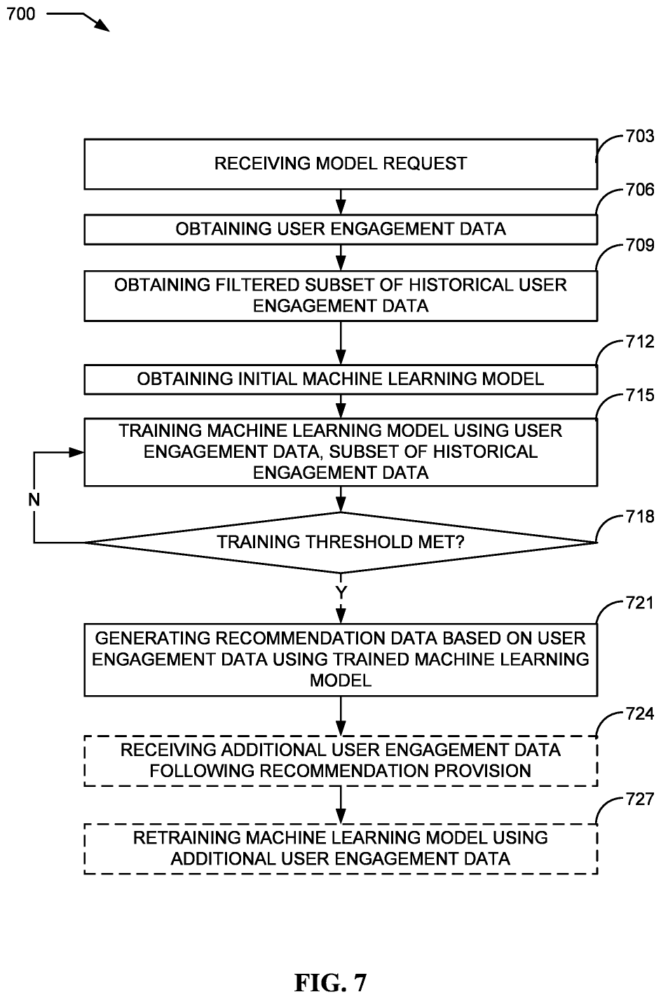

In various embodiments, the process 600 includes performing a training process 700 (e.g., as shown in FIG. 7 and described herein) to train one or more machine learning models using one or more training datasets 125. In some embodiments, the process 600 includes performing the process 700 prior to receipt of a recommendation request at operation 603. For example, the apparatus may perform the process 700 to train a machine learning model 123 using training data including user engagement data 115 associated with the target entity and historical user engagement data 117 associated with entities that are similar to the target entity. The apparatus may store the trained machine learning model 123 at the data store 102 in a model registry 121. The apparatus may retrieve the trained machine learning model 123 responsive to receiving the recommendation request of operation 603 such that the model may be used to generate predictive output based on stored and/or newly obtained user engagement data 115. In some embodiments, the retrieved machine learning model 123 may be further trained using newly obtained user engagement data 115.

The training dataset 125 may include a subset of the historical user engagement data associated with the subset of additional entities, which may be determined via techniques described herein in association with operations 615 and/or 618 (e.g., user engagement data segmentation and feature generation). In some embodiments, the apparatus performing the process 600 generates a model request, which may be processed to generate or retrieve a machine learning model for generating recommendation scores. For example, the apparatus may generate a model request that indicates the user-accessed application 105, the entity identifier of the target entity, entity identifiers of the determined subset of additional entities, one or more of the candidate applications 106, and/or the like. The apparatus may execute the model request using the prediction circuitry 212 to retrieve, from a model registry 121, a particular machine learning model 123 from a plurality of stored machine learning models 123. The particular machine learning model 123 may have been previously trained to generate predictive output respective to the user-accessed application 105, the target entity, the determined subset of additional entities, one or more of the candidate applications 106, and/or the like.

At operation 603, the process 600 includes receiving a request to generate a recommendation. For example, the apparatus performing the process 600 includes means, such as the processor 202, the memory 204, the input/output circuitry 206, the communication circuitry 208, or the like, for receiving a request recommendation from a user-accessed application 105. The recommendation request may include one or more entity identifiers associated with one or more entities for which recommendation data is requested. The recommendation request may include one or more application identifiers. For example, the recommendation request may include an application identifier for one or more user-accessed applications 105 such that predictive output for the entity may be generated based on user engagement data 115 associated with the one or more user-accessed applications 105. As another example, the recommendation request may include respective application identifiers for a plurality of candidate applications 106 for which recommendation scores are requested. In some contexts, the recommendation request may request consideration of all available candidate applications 106 or a particular subset of available candidate applications 106. For example, a recommendation request may instruct the model service 113 to generate recommendation scores for candidate applications 106 that were previously utilized by entities associated with the same domain as a target entity. As another example, the recommendation request may instruct the model service 113 to generate recommendation scores for candidate applications 106 that are associated with a technical role of the target entity. As described herein, a candidate application may embody an application, a particular version of an application, a particular level of entitlement to an application, one or more application features, and/or the like.

At operation 606, the process 600 includes determining one or more target entities associated with the recommendation request of operation 603. For example, the apparatus performing the process 600 includes means, such as the processor 202, the memory 204, the input/output circuitry 206, the communication circuitry 208, or the like for determining a target entity (e.g., also referred to as a “particular entity”) associated with an entity identifier obtained from the recommendation request. The entity identifier may be a unique identifier for a user account, a recommendation client device, an application instance or deployment, and/or the like. In one example, the apparatus may query one or more data stores 102 using an entity identifier to identify one or more stored entries of data associated therewith, which may include user engagement data 115, demographic data associated with the target entity, demographic data associated with a domain of the target entity, and/or the like.

At operation 609, the process 600 includes obtaining user engagement data associated with the target entity. For example, the apparatus performing the process 600 includes means, such as the processor 202, the memory 204, the input/output circuitry 206, the communication circuitry 208, the feature generation circuitry 210, or the like for receiving, from one or more data stores 102, user engagement data 115 associated with one or more user-accessed applications 105 and the entity identifier of the target entity. In some embodiments, the apparatus performing the process 600 obtains user engagement data 115 for a predetermined time interval, such as user engagement data generated from application interaction occurring within the past 12 hours, 24 hours, 6 days, 6 weeks, or any suitable period. As described herein, the user engagement data 115 may indicate actions performed within or otherwise respective to a user-accessed application 105. For example, the user engagement data 115 may indicate operations and functions performed by a user-accessed application 105 in response to user input. In another example, the user engagement data 115 may indicate when the target entity purchased the user-accessed application 105, upgraded or downgraded between versions of the user-accessed application 105, changed between levels of entitlement to the user-accessed application 105, and/or the like. As another example, the user engagement data 115 may indicate a level of utilization of the user-accessed application 105 by the target entity, such as a frequency of application interaction, duration of application interaction, or magnitude of application resources used.

At operation 612, the process 600 includes obtaining historical user engagement data associated with additional entities. For example, the apparatus performing the process 600 includes means, such as the processor 202, the memory 204, the input/output circuitry 206, the communication circuitry 208, the feature generation circuitry 210, the segmentation circuitry 211 or the like for receiving, from one or more data stores, one or more corpuses of historical user engagement data 117 associated with a plurality of additional entities. The apparatus performing the process 600 may obtain the historical user engagement data based on the recommendation request, the entity identifier of the target entity, the user engagement data obtained at operation 609, and/or the like. In some embodiments, the respective entities are associated with the one or more user-accessed applications 105 indicated by the recommendation request of operation 603. In some embodiments, the respective entities are further associated with one or more candidate applications 106 of a plurality of candidate applications 106 indicated by the recommendation request of operation 603. Alternatively, or additionally, in some embodiments, the apparatus performing the process 600 determines one or more additional entities that are associated with similar demographic data to the target entity and obtains historical user engagement data 117 associated with the determined entities. The demographic data may include associations with the same or similar domain, level of entitlement, technical role, location, and/or the like. In some embodiments, the historical user engagement data 117 includes respective demographic data for the respective entities, which may be further utilized to segment the historical user engagement data 117 for training machine learning models. In some embodiments, operation 612 is performed prior to receipt of the model request at operation 603. For example, the apparatus may perform operation 612 prior to operation 603 and to support operations of a training process 700 for training a machine learning model to generate predictive output respective to a target entity, domain, user-accessed application, candidate applications, and/or the like.

At operation 615, the process 600 includes performing a similarity analysis between the user engagement data of operation 609 and the historical user engagement data of operation 612 to determine a subset of the additional entities that demonstrate a threshold-satisfying similarity to the target entity. For example, the apparatus performing the process 600 includes means, such as the processor 202, the memory 204, the input/output circuitry 206, the communication circuitry 208, the feature generation circuitry 210, the segmentation circuitry 211 or the like for determining a subset of the plurality of additional entities associated with the particular entity by performing a similarity analysis between the user engagement data 115 and the corpus of historical user engagement data 117. In some embodiments, operation 615 is performed prior to receipt of the model request at operation 603. For example, the apparatus may perform operation 615 prior to operation 603 and to support operations of a training process 700 for training a machine learning model.

In some embodiments, performing the similarity analysis includes the apparatus generating one or more similarity metrics between the user engagement data 115 and subsets of the historical user engagement data 117 (e.g., each subset being associated with a respective entity). The similarity metrics may be Boolean conditionals, such as determinations of whether the target entity and additional entity are associated with a threshold number of applications and/or are associated with the same or similar locations, domains, technical roles, and/or the like. The similarity metrics may include computed similarity metrics, such as one or more Euclidean distances, Manhattan distances, Chebychev distances, Minkowski distances, cosine similarity scores, and/or the like. In some embodiments, the apparatus performing the similarity analysis compares the similarity metrics to one or more predetermined thresholds to determine whether the corresponding entity demonstrates sufficient similarity to the target entity. In some embodiments, operation 615 occurs prior to operation 603 such that machine learning models 123 are trained periodically using user engagement data 115 associated with the particular entity and historical user engagement data 117 for entities that demonstrate sufficient similarity to the particular entity. By training, storing, and retrieving specially configured machine learning models, the application recommendation system 101 may more rapidly and efficiently respond to recommendation requests (e.g., as compared to generating and training a new machine learning model 123 each time a recommendation request is received).

In some embodiments, the apparatus performing the process 600 performs the similarity analysis by segmenting the additional entities based on one or more segmentation factors (e.g., where a resultant segment of the additional entities embodies a subset of the additional entities having sufficient similarity to the target entity). In some contexts, the segmentation factor may include an application action record for one or more user-accessed applications 105 of the target entity. For example, entities that performed a particular application action (e.g., signup, engagement, purchase, and/or the like) within a predetermined interval (e.g., past 24 hours, past week, past quarter, or any suitable interval) may be identified and corresponding historical user engagement data 117 utilized for training purposes.

As another example, the segmentation factor may include a level of entitlement of the target entity for one or more user-accessed applications (e.g., the apparatus performing the process 600 may determine a subset of the additional entities associated with the same or similar level of entitlement). As another example, the segmentation factor may include domain similarity between a domain with which the target entity is associated and respective domains with which the additional entities are associated. As still another example, the segmentation factor may include demographic similarity between demographic data associated with the target entity and respective demographic data for the additional entities.

In some embodiments, at operation 615, the apparatus performing the process 600 segments the corpus of historical user data 117 based on the similarity analysis to obtain a subset of the historical user data 117 associated with one or more of the additional entities determined to demonstrate threshold-satisfying similarity to the target entity. In some embodiments, the apparatus stores or otherwise flags the subset of historical user data 117 in the data store 102 for subsequent use in generating one or more training datasets 125 for training a machine learning model 123 to generate predictive output respective to the target entity and the one or more user-accessed applications 105 associated therewith, such as recommendation scores for the plurality of candidate applications 106.

In some embodiments, at operation 615, the apparatus performing the process 600 generates one or more features based on the subset of historical user engagement data 117 associated with the subset of additional entities that were associated with the target entity based on the similarity analysis. In one example, the feature may be an application feature, such as a particular application action (e.g., application purchase, version change, and/or the like). The application feature may include one or more temporal features, such as an access interval indicative of recency of application engagement (e.g., past 24 hours, 6 days, or any suitable time period), duration of application engagement (e.g., 1 hour, 3 hours, or any suitable duration), and/or the like.

At operation 618, the process 600 includes generating respective recommendation scores for a plurality of candidate applications using a first machine learning model, which may be a model trained using the training process 700 and retrieved from a model repository. For example, the apparatus performing the process 600 includes means, such as the processor 202, the memory 204, the input/output circuitry 206, the communication circuitry 208, the feature generation circuitry 210, the segmentation circuitry 211, the prediction circuitry 212 or the like for generating, using a machine learning model 123, respective recommendation scores for the plurality of candidate applications 106 based on the user engagement data 115 of the target entity. As described, the machine learning model 123 for generating the recommendation scores is previously trained using the subset of the corpus of historical user engagement data 117 corresponding to the subset of the plurality of additional entities.

In some embodiments, the apparatus performing the process 600 generates one or more features based on the user engagement data 115 for use as input to the machine learning model 123. The features may include application features, temporal features, and/or the like. In some embodiments, the apparatus generates and assigns weights to the features to influence a level of contribution of the feature to the predictive output of the machine learning model 123. For example, the apparatus may weigh collaboration data based on a volume of the user cross-engagement indicated by the collaboration data (e.g., high volumes of cross-engagement may cause the apparatus to assign greater weight values to the collaboration data as compared to lower levels of cross-engagement). As another example, the apparatus may assign weight values to historical application actions of the target entity based on a respective recency of the application action, the type of application, and/or the like. In some contexts, particular application actions such as application purchases or version upgrades may be assigned a greater weight value as compared to other application actions, such as application trials or no-cost signups.

At operation 621, the process 600 optionally includes generating a ranking of candidate applications based on the respective recommendation scores. For example, the apparatus performing the process 600 includes means, such as the processor 202, the memory 204, the communications circuitry 208, or the like for generating a ranking of the plurality of candidate applications 106, where a top-ranked entry may be a candidate application 106 associated with a highest recommendation score. In some embodiments, the apparatus performing the process 600 determines a subset of the plurality of candidate applications 106 for which the corresponding recommendation score meets a predetermined score threshold. The apparatus may generate a ranking based on the subset of candidate applications 106 associated with threshold-satisfying recommendation scores.

At operation 624, the process 600 includes generating a recommendation for one or more candidate applications based on the recommendation scores of operation 618. For example, the apparatus performing the process 600 includes means, such as the processor 202, the memory 204, the input/output circuitry 206, the communication circuitry 208, the feature generation circuitry 210, the segmentation circuitry 211, the prediction circuitry 212 or the like for generating a recommendation for the target entity based on the respective recommendation scores. As one example, the apparatus performing the process 600 may train and execute a machine learning model to generate a natural language output embodying the recommendation. The recommendation indicates one or more of the plurality of candidate applications 106, such as a candidate application 106 associated with a highest recommendation score or a subset of the plurality of candidate applications 106 associated with respective recommendation scores determined to meet a predetermined score threshold. The recommendation may include an application identifier for the candidate application, an identifier for a recommended version of the candidate application, an identifier for a recommended level of the candidate application, and/or the like. The recommendation may include respective recommendation scores for the one or more recommended candidate applications 106. The reported recommendation score may indicate the quality of the predictive output to the entity. For example, the recommendation may include a top-ranked candidate application 106 from a recommendation score-based ranking of candidate applications 106. The recommendation may further include a recommendation score of the top-ranked candidate application 106, which may approximate the quality of the prediction to the user.

At operation 627, the process 600 optionally includes using a second machine learning model to generate a trigger event for provisioning the recommendation to the target entity (e.g., via provision of the recommendation to a recommendation client device 103 associated with the target entity). For example, the apparatus performing the process 600 includes means, such as the processor 202, the memory 204, the input/output circuitry 206, the communication circuitry 208, the feature generation circuitry 210, the segmentation circuitry 211, the prediction circuitry 212 or the like for generating, using a second machine learning model 123, a trigger event for causing provision of the recommendation to a recommendation client device 103 associated with the target entity. The second machine learning model 123 may have been previously trained by the apparatus using the user engagement data 115 and/or the subset of the historical user engagement data 117 to generate predictive output indicative of optimal trigger events for recommending one or more candidate applications 106. The trigger event may include an application action, a time interval, an application utilization level, and/or the like. In some embodiments, the apparatus performing the process 600 monitors for occurrence of the trigger event and/or causes the user-accessed application 105 to monitor for the trigger event. For example, the apparatus may provision recommendation data to the user-accessed application 105 including data indicative of a recommended candidate application 106 and a trigger event for initiating provision of a recommendation to the target entity.

At operation 630, the process 600 optionally includes determining whether the trigger event of operation 627 has occurred. For example, the apparatus performing the process 600 includes means, such as the processor 202, the memory 204, the input/output circuitry 206, the communication circuitry 208, the feature generation circuitry 210, the segmentation circuitry 211, the prediction circuitry 212 or the like for determining whether the trigger event has occurred based on the user engagement data 115 of operation 609 or additional user engagement data 115 obtained subsequent to generation of the trigger event. In some embodiments, in response to a positive determination that the trigger event has occurred, the process 600 proceeds to operation 633. In some embodiments, in response to determining the trigger event has not occurred, the process 600 may repeat operation 630 until such time that a positive determination of trigger event occurrence is made. In various embodiments, the process 600 omits operations 627 and 630 and proceeds from operation 624 to operation 633.

At operation 633, the process 600 includes causing provision of one or more recommendations to the one or more target entities of operation 606. For example, the apparatus performing the process 600 includes means, such as the processor 202, the memory 204, the input/output circuitry 206, the communication circuitry 208 or the like for causing provision of the recommendation generated at operation 624 to a recommendation client device 103 associated with the target entity. In some embodiments, the apparatus causes the user-accessed application 105 to provision the recommendation to the recommendation client device 103. The recommendation may be any suitable electronic signal or other transmission for indicating the recommended candidate application to the recommendation client device 103. In some embodiments, the recommendation embodies a notification rendered on a display of the recommendation client device 103, such as within a graphical user interface (GUI). In some embodiments, the GUI includes user input fields for receiving feedback from the target entity, such as an up-ranking or downranking of recommended candidate applications 106 or other input indicative of a “like” or “dislike” of a recommended application. The recommendation may include or embody an email, a short message service (SMS) message, in-application message, and/or the like that is provided to the recommendation client device 103 using one or more networks and, in some embodiments, as facilitated by one or more application programming interfaces (APIs). In some embodiments, the apparatus provisions recommendation data to the user-accessed application 105. The recommendation data may include one or more recommendation scores, application identifiers for corresponding candidate applications 106, rankings, draft recommendation language, trigger events, and/or the like. The provision of the recommendation data may cause the user-accessed application 105 to automatically or conditionally (based on the trigger event) provision a recommendation to the recommendation client device 103. In some embodiments, the apparatus performing the process 600 publishes one or more recommendations to a storage environment, such as one or more data stores. In some embodiments, the stored recommendations may be subsequently retrieved by the apparatus or recommendation client device for delivery to the target entity, such as in the form of an email campaign, push notification, and/or the like.

At operation 636, the process 600 optionally includes monitoring engagement of the target entity with the one or more recommended candidate applications. For example, the apparatus performing the process 600 and/or the user-accessed application 105 may monitor user engagement with the recommended candidate application by the target entity (e.g., including monitoring interactions between the associated recommendation client device and the recommended candidate application). As another example, the apparatus may receive one or more user inputs to a recommendation client device 103 that indicate feedback of the target entity to the recommendation (e.g., up-ranking, downranking, liking, or disliking a recommended application).

At operation 639, the process 600 optionally includes training the machine learning models of operation 618, operation 627, and/or the like based on user engagement data obtained at operation 636. For example, the apparatus performing the process 600 includes means, such as the processor 202, the memory 204, the input/output circuitry 206, the communication circuitry 208, the feature generation circuitry 210, the segmentation circuitry 211, the prediction circuitry 212 or the like for updating one or more training datasets 125 based on user engagement data obtained at operation 636, which may include engagement (or indicate a lack of engagement) between the target entity and the recommended candidate application. In some embodiments, the continued training of respective machine learning models following recommendation provision may improve the quality of predicted output generated by the machine learning model for the target entity. For example, the apparatus 200 may further train the machine learning model of operation 618 using user engagement data indicative of whether the target entity performed an application action respective to a recommended candidate application.

FIG. 7 is a flowchart diagram of an example training process 700 for training a machine learning model to generate predictive output for improving application utilization in accordance with at least some embodiments of the present disclosure. The process 700 may be performed by various embodiments of the application recommendation system 101. For example, the process 700 may be performed by an apparatus 200 that embodies functionality of the application recommendation system 101 described herein. In some embodiments, the apparatus performs the process 700 asynchronously to recommendation generation processes. For example, the apparatus may perform the process 700 periodically (e.g., every 12 hours, 2 days, 6 days, or any suitable interval) using user engagement data associated with a particular entity and historical user engagement data associated with one or more additional entities determined to demonstrate threshold-satisfying similarity to the particular entity. The apparatus may perform the process 700 in batch (e.g., asynchronously) using stored user engagement data. In some contexts, the apparatus may perform the process 700 in near real-time to generation and collection of user engagement data. In some contexts, the apparatus may perform the process 700 in response to detecting one or more events, such as a determination that a previous target entity performed a recommended application action or that the previous target entity failed to perform a recommended application action within a predetermined period following recommendation provisioning. The apparatus may generate, train, and store specially configured machine learning models for subsequent retrieval and use in responding to recommendation requests associated with the particular entity. By utilizing pre-trained, personalized machine learning models, the apparatus may more rapidly and efficiently respond to subsequent recommendation requests.

At operation 703, the process 700 includes receiving a model request. For example, the apparatus performing the process 700 includes means, such as the processor 202, the memory 204, the input/output circuitry 206, the communication circuitry 208, the feature generation circuitry 210, the segmentation circuitry 211, the prediction circuitry 212 or the like for receiving a model request. In some embodiments, the model request is generated automatically, such as in response to the apparatus determining a predetermined time period has elapsed (e.g., 12 hours, 3 days, 6 days, 1 week, or any suitable interval) or in response to the apparatus obtaining new engagement data for a particular entity associated with a stored machine learning model or additional entities determined to be similar to the particular entity. The model request may include one or more identifiers including identifiers for one or more user-accessed applications 105, an entity identifier of a target entity, entity identifiers of additional entities having been determined to be similar to the target entity, identifiers for one or more of the candidate applications 106, and/or the like.

At operation 706, the process 700 includes obtaining user engagement data 115 based on the model request. For example, the apparatus performing the process 700 includes means, such as the processor 202, the memory 204, the input/output circuitry 206, the communication circuitry 208, the feature generation circuitry 210, the segmentation circuitry 211, the prediction circuitry 212 or the like for obtaining user engagement data 115 based on the identifiers for one or more user-accessed applications 105, the entity identifier of the target entity, and/or the like. In some embodiments, the apparatus obtains a filtered subset of user engagement data 115 associated with a predetermined time interval, such as a predetermined time period preceding receipt of the model request and/or time intervals corresponding to periods in which the target entity engaged with the user-accessed application 105 for a predetermined duration or utilization level. In some embodiments, the data obtained at operation 706 includes one or more features generated by the apparatus based on the user engagement data 115.

At operation 709, the process 700 includes obtaining a filtered subset of historical user engagement data 117, which may be a subset of historical user engagement data 117 associated with one or more additional entities determined to demonstrate threshold-satisfying similarity (or other association) to the target entity. For example, the apparatus performing the process 700 includes means, such as the processor 202, the memory 204, the input/output circuitry 206, the communication circuitry 208, the feature generation circuitry 210, the segmentation circuitry 211, the prediction circuitry 212 or the like for obtaining the filtered subset of historical user engagement data 117 from a data store. In some embodiments, the data obtained at operation 709 includes one or more features generated by the apparatus based on the filtered subset of historical user engagement data 117. The historical user engagement data 117 for a respective additional entity may include a first set of data associated with engagement of the entity with one or more user-accessed applications 105 indicated by the model request and a second set of data associated with engagement of the entity with one or more candidate applications 106 indicated by the model request.

In some embodiments, obtaining the filtered subset of historical user engagement data 117 includes obtaining one or more training datasets 125 from the model registry 121. For example, the apparatus may retrieve a training dataset 125 from the model registry 121 based on entity identifiers for the additional entities associated with the target entity, one or more application identifiers for the candidate applications 106, an application identifier for the user-accessed application 105, a domain identifier for a domain associated with the target entity, and/or the like.

At operation 712, the process 700 includes obtaining an initial machine learning model 123. For example, the apparatus performing the process 700 includes means, such as the processor 202, the memory 204, the input/output circuitry 206, the communication circuitry 208, the feature generation circuitry 210, the segmentation circuitry 211, the prediction circuitry 212 or the like for generating the initial machine learning model 123 or receiving a stored machine learning model 123 from the model registry 121 (e.g., based on one or more identifiers including identifiers for one or more user-accessed applications 105, an entity identifier of the target entity, entity identifiers of the additional, identifiers for one or more of the candidate applications 106, and/or the like).

At operation 715, the process 700 includes training the initial machine learning model 123 (or retraining a subsequent trained version of the machine learning model 123) using one or more training datasets including the historical user engagement data 117 obtained at operation 709. For example, the apparatus performing the process 700 includes means, such as the processor 202, the memory 204, the input/output circuitry 206, the communication circuitry 208, the feature generation circuitry 210, the segmentation circuitry 211, prediction circuitry 212 or the like for training the initial machine learning model 123 or a subsequent trained version thereof. In some embodiments, training the machine learning model 123 includes the apparatus processing the historical user engagement 117 (or features derived therefrom) using the machine learning model 123 to generate output including one or more recommendation scores, trigger events, and/or the like for the entities associated with the historical user engagement data. The apparatus performing the process 700 may compare the recommendation scores, trigger events, and/or the like to respective application action records of the entities to determine an accuracy level of the recommendation output, such as (i) whether an entity performed an application action respective to a candidate application associated with a highest recommendation score and/or (ii) whether the entity performed the application action following a trigger event.

At operation 718, the process 700 includes determining whether the current trained iteration of the machine learning model 123 meets one or more training thresholds, such as one or more thresholds for prediction accuracy, prediction precision, robustness, trust, and/or the like. For example, the apparatus performing the process 700 includes means, such as the processor 202, the memory 204, the input/output circuitry 206, the communication circuitry 208, the feature generation circuitry 210, the segmentation circuitry 211, prediction circuitry 212 or the like for determining whether the current trained iteration of the machine learning model meets the training threshold. In response to the apparatus determining the current iteration of the machine learning model 123 meets the training threshold, the process 700 proceeds to operation 721. In response to the apparatus determining the current iteration of the machine learning model 123 fails to meet the training threshold, the process 700 may proceed to operation 715 at which the apparatus may adjust one or more parameters, hyperparameters, and/or the like of the machine learning model 123 to generate a subsequent trained iteration thereof, the performance of which may be further tested and evaluated at operations 715-718. The process 700 may include repeating operations 715-718 until a trained iteration of the machine learning model 123 that meets the training threshold is generated.

At operation 721, the process 700 includes generating recommendation data 119 based on the user engagement data 115 of operation 706 using the machine learning model 123 of operations 715-718. For example, the apparatus performing the process 700 includes means, such as the processor 202, the memory 204, the input/output circuitry 206, the communication circuitry 208, the feature generation circuitry 210, the segmentation circuitry 211, prediction circuitry 212 or the like for generating recommendation data 119 based on the user engagement data 115, where the recommendation data 119 may include recommendation scores for the plurality of candidate applications 106, trigger events for one or more candidate applications 106, and/or the like. The apparatus performing the process 700 may utilize the recommendation data 119 to generate one or more recommendations for one or more candidate applications 106 and/or provision the recommendation data 119 to the user-accessed application 105.

At operation 724, the process 700 optionally includes receiving additional user engagement data 115 following provision of a recommendation to the target entity. For example, the apparatus performing the process 700 includes means, such as the processor 202, the memory 204, the input/output circuitry 206, the communication circuitry 208, the feature generation circuitry 210, the segmentation circuitry 211, prediction circuitry 212 or the like for receiving additional user engagement data 115 associated with an interval following provision of a recommendation for a candidate application 106 to a recommendation client device 103 of the target entity.

At operation 727, the process 700 optionally includes retraining the machine learning model 123 of operation 721 using the additional user engagement data 115. For example, the apparatus performing the process 700 includes means, such as the processor 202, the memory 204, the input/output circuitry 206, the communication circuitry 208, the feature generation circuitry 210, the segmentation circuitry 211, prediction circuitry 212 or the like for further training the machine learning model 123 using the additional user engagement data 115, which may improve subsequent model performance due to the additional user engagement data 115 indicating whether the target entity performed one or more application actions respective to a recommended candidate application 106.

### Additional Implementation Details

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer-readable storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially-generated propagated signal. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (Application Specific Integrated Circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's query-initiating computing device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a query-initiating computing device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., a Hypertext Markup Language (HTML) page) to a query-initiating computing device (e.g., for purposes of displaying information/data to and receiving user input from a user interacting with the query-initiating computing device). Information/data generated at the query-initiating computing device (e.g., a result of the user interaction) can be received from the query-initiating computing device at the server.

While this specification contains many specific implementation details, these should not be construed as limitations on the scope of any inventions or of what may be claimed, but rather as description of features specific to particular embodiments of particular inventions. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

### CONCLUSION

Many modifications and other embodiments of the inventions set forth herein will come to mind to one skilled in the art to which these inventions pertain having the benefit of the teachings presented in the foregoing description and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. A computer-implemented method for optimizing application utilization, comprising:
receiving, from at least one data store, user engagement data associated with at least one user-accessed application and an identifier of a particular domain, wherein the domain is associated with a plurality of end-users of a particular instance of the at least one user-accessed application;
receiving, from the at least one data store, a corpus of historical user engagement data associated with a plurality of additional entities, wherein respective entities of the plurality of additional entities are associated with the at least one user-accessed application and at least one of a plurality of candidate applications;
determining a subset of the plurality of additional entities associated with the particular domain by performing a similarity analysis between the user engagement data and the corpus of historical user engagement data;
generating, using a machine learning model, respective recommendation scores for the plurality of candidate applications based on the user engagement data, wherein:
the machine learning model was previously trained using a subset of the corpus of historical user engagement data corresponding to the subset of the plurality of additional entities; and
the recommendation score indicates a likelihood of the plurality of end-users of the particular domain performing at least one application action respective to the corresponding candidate application;
generating a recommendation for the particular domain based on the respective recommendation scores, wherein the recommendation indicates at least one of the plurality of candidate applications; and
causing provision of the recommendation to the at least one user-accessed application, wherein the user-accessed application causes provision of the recommendation to a computing device associated with the identifier of the particular domain.

2. The method of claim 1, wherein:
the recommendation is provisioned to the computing device via rendering of a graphical user interface (GUI) on a display of the computing device;
the GUI comprises a user input field configured to receive user feedback to the recommendation from at least one of the plurality of end-users; and
the method further comprises:
retraining the machine learning model using at least one user input received via the user input field.

3. The method of claim 1, wherein:
the at least one application action is at least one of an application purchase, an application version change, or an application trial.

4. The method of claim 1, further comprising:
generating a ranking of the plurality of candidate applications based on the respective recommendation scores, wherein the recommendation comprises a subset of top-ranked entries from the ranking for which the corresponding recommendation score meets a predetermined threshold.

5. The method of claim 1, further comprising:
generating, using a second machine learning model, a trigger event for causing provision of the recommendation to the computing device associated with the domain identifier, wherein:
the second machine learning model was previously trained using the user engagement data and the subset of the corpus to generate predictive output indicative of optimal trigger events for recommending the at least one of the plurality of candidate applications; and
in response to receiving an indication of an occurrence of the trigger event, causing the at least one user-accessed application to initiate the provision of the recommendation to the computing device associated with the domain identifier.

6. The method of claim 5, wherein:
the trigger event comprises at least one action initiated by at least one of the plurality of end-users within the particular instance of the at least one user-accessed application.

7. The method of claim 5, wherein:
the trigger event comprises a particular time interval.

8. The method of claim 5, wherein:
the trigger event comprises a predetermined utilization level of the at least one user-accessed application by at least one of the plurality of end-users.

9. The method of claim 1, wherein:
the user engagement data comprises at least one application feature associated with the at least one user-accessed application or one or more historical user-accessed applications associated with the domain identifier.

10. The method of claim 9, wherein:
the user engagement data further comprises at least one temporal feature associated with the at least one application feature.

11. The method of claim 9, wherein:
the at least one application feature comprises at least one application action; and
the at least one application action is at least one of an application purchase, an application upgrade, an application downgrade, or an application removal.

12. The method of claim 1, wherein:
the user engagement data and the corpus of historical user engagement data are received from a remote feature service comprising the at least one data store.

13. The method of claim 1, further comprising:
providing, to a model service, a model request, wherein the model request indicates at least one of the at least one user-accessed application, the domain identifier, or the subset of the plurality of additional entities; and
receiving, from the model service, the machine learning model, wherein the model service retrieves the machine learning model from a plurality of stored machine learning models based on the model request.

14. An apparatus optimizing application utilization, the apparatus comprising at least one processor and at least one non-transitory memory comprising program code, wherein the at least one non-transitory memory and the program code are configured to, with the at least one processor, cause the apparatus to:
receive, from at least one data store, user engagement data associated with at least one user-accessed application, wherein the user engagement data is associated with an entity identifier of a particular entity;
receive, from the at least one data store, a corpus of historical user engagement data associated with a plurality of additional entities, wherein respective entities of the plurality of additional entities are associated with the at least one user-accessed application and at least one of a plurality of candidate applications;
determine a subset of the plurality of additional entities associated with the particular entity by performing a similarity analysis between the user engagement data and the corpus of historical user engagement data;
generate, using a machine learning model, respective recommendation scores for the plurality of candidate applications based on the user engagement data, wherein:
the machine learning model was previously trained using a subset of the corpus of historical user engagement data corresponding to the subset of the plurality of additional entities; and
the recommendation score indicates a likelihood of the particular entity performing at least one application action respective to the corresponding candidate application;
generate a recommendation for the particular entity based on the respective recommendation scores, wherein the recommendation indicates at least one of the plurality of candidate applications; and
cause provision of the recommendation to the at least one user-accessed application, wherein the at least one user-accessed application causes provision of the recommendation to a computing device associated with the entity identifier.

15. The apparatus of claim 14, wherein:
the recommendation further indicates the corresponding recommendation score for the at least one of the plurality of candidate applications.

16. The apparatus of claim 14, wherein the at least one non-transitory memory and the program code are further configured to, with the at least one processor, further cause the apparatus to:
perform the similarity analysis by segmenting the plurality of additional users based on at least one segmentation factor to determine the subset of the plurality of additional entities associated with the particular entity.

17. The apparatus of claim 16, wherein:
the at least one segmentation factor comprises an application action record for the at least one user-accessed application.

18. The apparatus of claim 16, wherein:
the at least one segmentation factor comprises domain similarity between a domain associated with the particular entity and a respective domain associated with the plurality of additional entities.

19. The apparatus of claim 16, wherein:
the at least one segmentation factor comprises demographic similarity between demographic data associated with the particular entity and respective demographic data for the plurality of additional entities;
the user engagement data comprises the demographic data associated with the particular entity; and
the corpus of historical user engagement data comprises the respective demographic data for the plurality of additional entities.

20. A computer program product optimizing application utilization, the computer program product comprising at least one non-transitory computer-readable storage medium having computer-readable program code portions stored therein, the computer-readable program code portions configured to:
receive, from at least one data store, user engagement data associated with at least one user-accessed application, wherein the user engagement data is associated with an entity identifier of a particular entity;
receive, from the at least one data store, a corpus of historical user engagement data associated with the particular entity and a plurality of additional entities, wherein respective entities of the plurality of additional entities are associated with the at least one user-accessed application and at least one of a plurality of candidate applications;
determine a subset of the plurality of additional entities associated with the particular entity by performing a similarity analysis between (i) a dataset comprising the user engagement data and a subset of the corpus of historical user engagement data corresponding to the particular entity and (ii) a subset of the corpus of historical user engagement data corresponding to the plurality of additional entities;
generate, using a machine learning model, respective recommendation scores for the plurality of candidate applications based on the user engagement data, wherein:
the machine learning model was previously trained using a subset of the corpus of historical user engagement data corresponding to the subset of the plurality of additional entities; and
the recommendation score indicates a likelihood of the particular entity performing at least one application action respective to the corresponding candidate application;
generate a recommendation for the particular entity based on the respective recommendation scores, wherein the recommendation indicates at least one of the plurality of candidate applications; and
cause provision of the recommendation to the at least one user-accessed application, wherein the at least one user-accessed application causes provision of the recommendation to a computing device associated with the entity identifier.
